(19) United States
(12) Patent Application Publication
(10) Pub. No.: US 2015/0340872 A1
(43) Pub. Date: Nov. 26, 2015

(54) ELECTRICAL CONNECTOR PARTS FOR COMBINING POWER DELIVERY AND SIGNALING IN INDUCTIVELY COUPLED CONNECTORS

(71) Applicant: North Carolina State University, Raleigh, NC (US)

(72) Inventors: Paul D. Franzon, New Hill, NC (US); Evan L. Erickson, Raleigh, NC (US); Peter Gadfort, Washington, DC (US)

(21) Appl. No.: 14/286,985

(22) Filed: May 23, 2014

(51) Int. Cl. H02J 5/00

(52) U.S. Cl. CPC H02J 5/005

(57) ABSTRACT

Electrical connector parts for combining power delivery and signaling in inductively coupled connectors are disclosed. According to one aspect, an electrical connector part includes a first mating connector face having disposed thereon a first set of inductors and also includes a mechanical interface that is configured to maintain the first mating connector face in closely spaced apart relation to a second mating conductor face having disposed thereon a second set of inductors. The mechanical interface is designed to prevent DC coupling and provide inductive AC coupling between at least one pair of inductors made up of one inductor from the first set of inductors and one inductor from the second set of inductors. The first set of inductors includes a power inductor of a first size for transferring power and a data inductor of a second size different from the first size for transferring data.

### TECHNICAL FIELD

The subject matter described herein relates to methods and systems for inductively coupled connectors. More particularly, the subject matter described herein relates to electrical connector parts for combining power delivery and signaling in inductively coupled connectors.

### BACKGROUND

Space is at a premium in modern mobile devices as manufactures strive to make the thinner, lighter devices with the longest battery lives possible. By transitioning from legacy connectors, such as micro-USB and tip-ring-sleeve (TRS) audio jacks, to a low-profile inductively coupled connector for the transmission of both power and high-speed data, space inside the mobile device can be conserved while providing an orientation independent, waterproof design that can breakaway when stressed.

Power and data transfer through inductive coupling has been demonstrated in radio frequency identification (RFID) for medical implants and smart cards, inductive charging of toothbrushes, and even in induction cooktops. Most of these systems rely on relatively large inductors, which are better suited to transfer power than data, and in many systems the data is communicated by modulating the power carrier amplitude.

Inductive power transfer can be considered a loosely coupled transformer with one side containing a power amplifier or other broadcasting circuitry tuned to the resonant frequency of the transformer. The other side contains a recovery circuit, which generally converts the power from AC to DC power. One of the main advantages of inductively coupled power is that it allows isolated systems to be powered without a direct connection and has been used in a variety of systems, such as a medically implanted device, where a direct connection can greatly increase the risk of infection. In these applications, the size of the device and power delivery is paramount, while the speed of data transfer is usually less important [1].

High-speed data transfer over an inductive connection was initially proposed to increase the achievable density of I/O in integrated circuits compared to solder bump arrays by using smaller transformers approximately 50 μm in diameter to transfer only the AC components of a signal [2]. A transceiver consisting of a current steering differential driver and a current-mode pulse receiver were examined while the complete I/O system contained a series of buried solder bumps to provide power and ground between systems. Inductive interconnects to complement or replace through silicon vias (TSVs) for 3-D data transfer between thinned die have been extensively researched [3] [4]. As TSV replacements, transformers roughly 100 μm in diameter are used to couple multi-Gbps data across distances approximately 25 μm. Finally, a zero-insertion force backplane connector composed of transformers with diameters ranging from 1 to 10 mm on low-cost PCBs has been proposed [5]. It was determined that multi-Gbps signaling was achievable, though the relatively large minimum width and spacing of the PCB process resulted in a transformer which suffered from losses at high-frequency and therefore could not support sufficient data rates, however.

Accordingly, in light of these disadvantages associated with existing inductively coupled connectors, there exists a need for electrical connector parts for combining power delivery and signaling in inductively coupled connectors.

### SUMMARY

According to one aspect, the subject matter described herein includes an electrical connector part that includes a first mating connector face having disposed thereon a first set of inductors and that also includes a mechanical interface that is configured to maintain the first mating connector face in closely spaced apart relation to a second mating conductor face having disposed thereon a second set of inductors. The mechanical interface is designed to prevent DC coupling and provide inductive AC coupling between at least one pair of inductors made up of one inductor from the first set of inductors and one inductor from the second set of inductors. The first set of inductors includes a power inductor of a first size for transferring power and a data inductor of a second size different from the first size for transferring data.

According to another aspect, the subject matter described herein includes an electrical connector part that includes a first mating connector face having disposed thereon a first power inductor for transferring power and a first optical device for transmitting or receiving data. The electrical connector part also includes a mechanical interface that is configured to maintain the first mating connector face in closely spaced apart relation to a second mating conductor face having disposed thereon a second power inductor for transferring power and a second optical device for transmitting or receiving data to prevent DC coupling, to provide inductive AC coupling between the first and second power inductors, and to provide optical communication between the first and second optical devices.

According to yet another aspect, the subject matter described herein includes an electrical connector part that includes a first mating connector face having disposed thereon a first set of inductors and that includes a mechanical interface that is configured to maintain the first mating connector face in closely spaced apart relation to a second mating conductor face having disposed thereon a second plurality of inductors. The mechanical interface is designed to prevent DC coupling and to provide inductive AC coupling between at least one pair of inductors comprising one inductor from the first set of inductors and one inductor from the second set of inductors. Each of the first and second pluralities of inductors includes a power inductor for transmitting power between the first and second mating connector faces and at least one data inductor for transmitting data between the first and second mating connector faces. The patterns of the first and second sets of inductors provide inductive AC coupling between at least one pair of inductors comprising a data inductor on the first mating connector face and a data inductor on the second mating connector face regardless of the orientation of the first and second mating connector faces relative to each other.

According to yet another aspect, the subject matter described herein includes an electrical connector part having a first mating connector face having disposed thereon a first set of inductors, which includes a power inductor for transferring power and a data inductor for transferring data. The part includes a mechanical interface that is configured to maintain the first mating connector face in closely spaced apart relation to a second mating conductor face having disposed thereon a second set of inductors. The mechanical interface is designed to prevent DC coupling and to provide inductive AC coupling between at least one pair of data inductors comprising one data inductor from the first set of inductors and one data inductor from the second set of inductors. The part includes an equalization (EQ) circuit for performing multi-bit fractional equalization of the data being transferred.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings, wherein like reference numerals represent like parts, of which:

FIG. 1A is a plan view of a contactless connector design for combining power delivery and signaling in inductively coupled connectors according to an embodiment of the subject matter described herein;

FIG. 1B is an orthogonal view of a pair of connectors using a contactless connector design for combining power delivery and signaling in inductively coupled connectors according to an embodiment of the subject matter described herein;

FIG. 2 illustrates a contactless connector design that incorporates inductive coupling coils for both power and data transfer in a nested design according to an embodiment of the subject matter described herein;

FIG. 3 is a graph illustrating the effect that increasing the number of turns of the power inductor has on the strength of the transferred signal and on the frequency at which peak coupling occurs;

FIG. 4 is a graph illustrating the effect that increasing the number of turns of the data inductor has on the characteristics of the transferred signal;

FIG. 5 is a graph illustrating the effect of crosstalk between the power and data channels of a connector according to an embodiment of the subject matter described herein at various spacings;

FIGS. 6 and 7 are graphs illustrating the effect of increasing the gap between the connectors for the power and data channels, respectively, of a contactless connector design for combining power delivery and signaling in inductively coupled connectors according to an embodiment of the subject matter described herein;

FIG. 8 is a graph illustrating how data inductor/data inductor spacing affects crosstalk;

FIG. 9 is an plan view of a contactless connector design for combining power delivery and signaling in inductively coupled connectors according to another embodiment of the subject matter described herein;

FIGS. 10 and 11 are plan views of a contactless connector design for combining power delivery and signaling in inductively coupled connectors according to other embodiments of the subject matter described herein;

FIG. 12 is an plan view of a pair of connectors for combining power delivery and signaling in inductively coupled connectors according to another embodiment of the subject matter described herein;

FIG. 13 shows a conventional tip-ring-sleeve (TRS) headphone plug;

FIG. 14 illustrates an exemplary contactless connector design for combining power delivery and signaling in inductively coupled connectors according to an embodiment of the subject matter described herein;

FIG. 15 is a graph illustrating an exemplary contactless connector design for combining power delivery and signaling in inductively coupled connectors according to an embodiment of the subject matter described herein over a range of frequencies;

FIG. 16 is a block diagram illustrating an exemplary headphone circuit using a contactless connector design for combining power delivery and signaling in inductively coupled connectors according to an embodiment of the subject matter described herein;

FIG. 17 is a circuit diagram illustrating an exemplary differential driver suitable for use as current-mode driver in the headphone circuit of FIG. 16;

FIG. 18 is a circuit diagram illustrating an exemplary differential receiver suitable for use as pulse receiver in the headphone circuit of FIG. 16;

FIG. 19 is a waveform showing an example PWM output for a 5 kHz tone;

FIG. 20 is a graph showing the corresponding frequency spectrum for the PWM waveform shown in FIG. 19;

FIG. 21 illustrates an embodiment in which the inductors on either side of contactless connector according to an embodiment illustrated herein could be created on flexible printed circuit board (PCB);

FIGS. 22 and 23 are plan views of contactless connector designs for combining power delivery and signaling in inductively coupled connectors according to other embodiments of the subject matter described herein;

FIG. 24 illustrates an example mobile device resting on a charging pad, each of which including a contactless connector design for combining power delivery and signaling in inductively coupled connectors according to an embodiment of the subject matter described herein;

FIG. 25 illustrates an exemplary dithering pattern that may be employed by a mobile device and charging pad for combining power delivery and signaling in inductively coupled connectors according to embodiments of the subject matter described herein;

FIGS. 26 and 27 are plots of an example input signal into a transformer and the output of the transformer, respectively;

FIG. 28A is a plot showing how the shape of the output pulse changes as the transformer characteristics change;

FIG. 28B is a plot showing the effect of increased gap between the two inductors on the shape of the output pulse;

FIG. 29 is an eye diagram showing the effect of increased decay times, i.e., inter-symbol interference, or ISI;

FIG. 30 is a graph illustrating an example multi-bit fractional EQ profile according to an embodiment of the subject matter described herein;

FIGS. 31 and 32 illustrate a multi-bit fractionally equalized input stream and its corresponding output stream, respectively, according to an embodiment of the subject matter described herein;

FIG. 33 is a waveform showing the natural decay time for a transformer;

FIG. 34 is a waveform showing the eye diagram of data being transmitted at 4 Gbps using a transformer that is larger than the one used to produce the waveform in FIG. 33, without equalization;

FIG. 35 is a waveform showing the eye diagram of data being transmitted using the larger transformer, with fractional equalization according to an embodiment of the subject matter described herein; and

FIGS. 36 and 37 are simulated eye diagrams for signals being transmitted at 10 Gbps using the larger transformer, without and with equalization, respectively.

### DETAILED DESCRIPTION

In accordance with the subject matter disclosed herein, electrical connector parts for combining power delivery and signaling in inductively coupled connectors are provided.

A nested inductive connector, consisting of a single power channel and one or more data channels, is proposed as replacement for legacy conductive connectors in mobile devices. Advantages include minimized space in the mobile device, waterproofing, orientation independence, and resistance to stress through a breakaway mechanism. A simulation and analysis of relevant parameters, such as the transfer coefficients for both the power and data channels as well as crosstalk, of the connector design for a simple 2-layer PCB is presented. As an example, the proposed connector is utilized as a replacement for a standard TRS headphone jack found on many mobile devices. The connector features an AC to DC rectifier, data transmitting circuits, as well as a Class-D power amplifier to drive a pair of headphones.

Reference will now be made in detail to exemplary embodiments of the present invention, examples of which are illustrated in the accompanying drawings. Wherever possible, the same reference numbers will be used throughout the drawings to refer to the same or like parts.

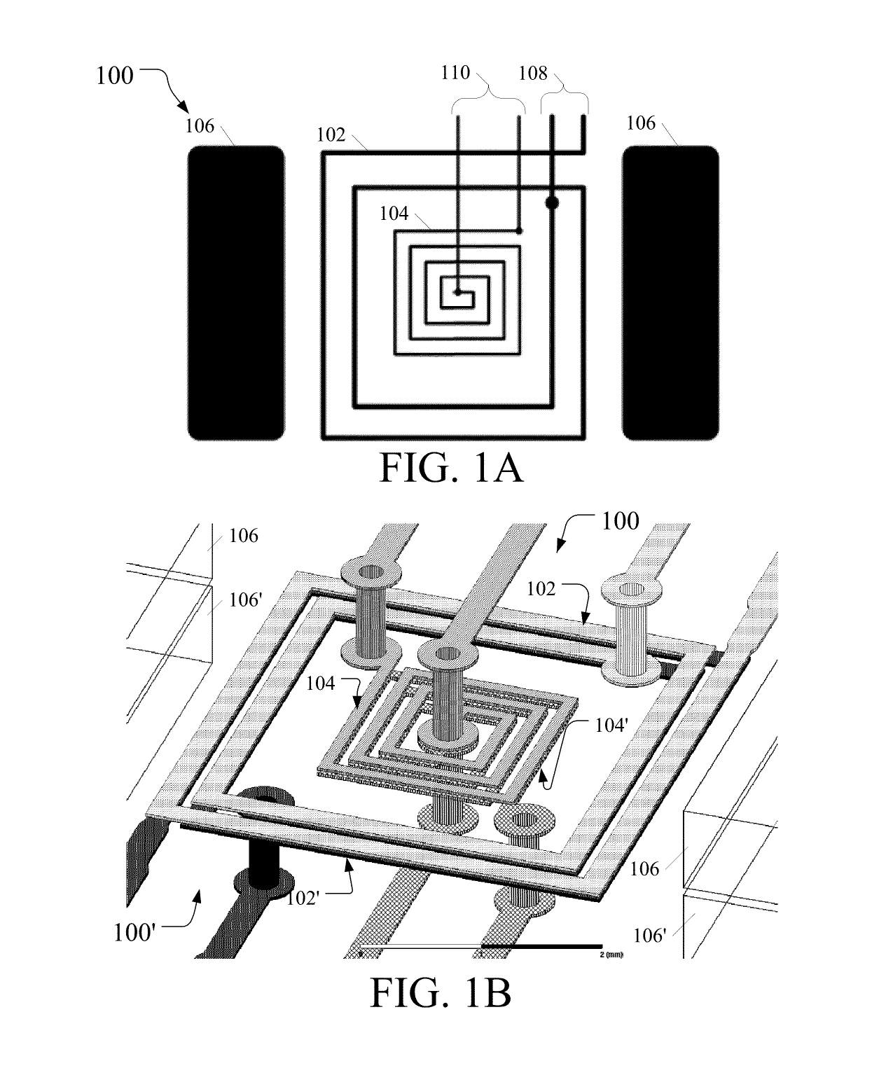

FIG. 1A is a plan view of a contactless connector design for combining power delivery and signaling in inductively coupled connectors according to an embodiment of the subject matter described herein. In one embodiment, a connector 100 includes a power inductor 102 and one or more data inductors 104. In one embodiment, the inductors are manufactured such that they are in the same plane with respect to each other. In the embodiment illustrated in FIG. 1, connector 100 includes one data inductor positioned within the same plane as power inductor 102 and located inside the loops of power inductor 102, i.e., surrounded by power inductor 102. In one embodiment, power inductor 102 is relatively large in order to improve power transfer efficiency of the transformer created by the mated pair of power inductors. Data inductor 104 on the other hand, is relatively small to enable high-speed data transfer. If data inductor 104 is too large, the maximum data transfer speed is limited. If data inductor 104 is too small, however, it be unable to inductively couple with the inductor on the opposite connector. The smaller size of the data transformer(s) created by a pair of mated smaller inductors increase the frequency at which peak coupling occurs into the multi-GHz range, allowing for AC signaling with a current-mode pulse receiver. Through intelligent design of the inductors and the spacing between them, an inexpensive connector can be constructed using a simple 2-layer PCB.

Magnets can potentially be used on all or some of the sides of the connector to provide a strong structural connection and bring the inductors on either side of the connector within close proximity to create transformers. This allows for the physical connection of the connector to be easily severed without damaging the connector. The magnets also allow for a low profile connector by allowing the male end of the connector to minimally insert into the female side, thus saving space on the female side of the connector and any devices that utilize it. In the embodiment illustrated in FIG. 1, for example, connector 100 includes two magnets 106, one on each side of connector 100.

Power inductor 102 is supplied with current via a pair of terminals 108. Data inductor 104 is supplied with current via a pair of terminals 110. In the embodiment illustrated in FIG. 1A, power inductor 102 is not the same size as data inductor 104. In alternative embodiments, the same size inductor may be used for both power and data transfer. As will be described below, however, the use of big inductors for data transfer raises additional technical challenges that must be addressed.

Inductors on either side of the connector may be encased within plastic or some other material that prevents the inductors from making a physical conductive connection when brought into close proximity with each other. This allows the inductors to be brought as close together as the encasing material will allow without making a conductive connection and allowing the connector to function under water.

Thus, a connector enabling the contactless transfer of both power and high-speed data can be created by incorporating separate inductors into a unified design. By combining one or more relatively small data transformers within a larger power transformer, both transfers can occur over separate channels, optimized for their unique operation. Designing the proposed connector for a two-layer PCB with a 100 μm metal width and spacing and a 500 μm diameter via, the effects of changing parameters, such as the data to power spacing, and the effect of magnets were examined using simulations. This process allows for a minimal sized connector of approximately 3 mm×3 mm, which is comparable to the smallest conductive connector currently available. One such design is illustrated in FIG. 1B.

FIG. 1B is an orthogonal view of a pair of connectors 100 (on top) and 100′ (on bottom) making an inductive connection with each other. In the embodiment illustrated in FIG. 1B, top connector 100 and its components 102, 104, and 106 are in close proximity bottom connector 100′ and its corresponding components 102′, 104′, and 106′, but are not touching. In this manner, power inductors 102 and 102′ are inductively coupled and data inductors 104 and 104′ are also inductively coupled. In one embodiment, magnets 106 and 106′ hold connectors 100 and 100′ in place by magnetic attraction. This allows the connector pair 100 and 100′ to be joined without the need for a socket and plug or other electrical connection. Since there is no connection hardware, there is nothing to damage when these connectors are separated intentionally or accidently.

By symmetrically incorporating smaller inductors used for high-speed data transmission within a larger inductor used for power transfer, a connector can be created which can be connected in multiple orientations (such as right-side-up and upside-down), thus allowing for easier connections without regard to cable orientation. In the embodiment illustrated in FIG. 1B, for example, the top connector 100 may be rotated around an axis that is normal to the plane of the inductors and centered through data inductor 104 and that this rotation relative to bottom connector 100′ may be by any number of degrees from the orientation shown in FIG. 1B and the connection will still operate correctly. Magnets 106 and 106′ are optional, and in the embodiment illustrated in FIG. 1B, magnets 106 and 106 will operate to constrain the position of top connector 100 to two positions: the one shown in FIG. 1B and another that is 180 degrees rotated from the position shown in FIG. 1B. As will be described in more detail below, even connectors having multiple data inductors 104 may be designed to operate regardless of the relative rotational positions of the two connectors.

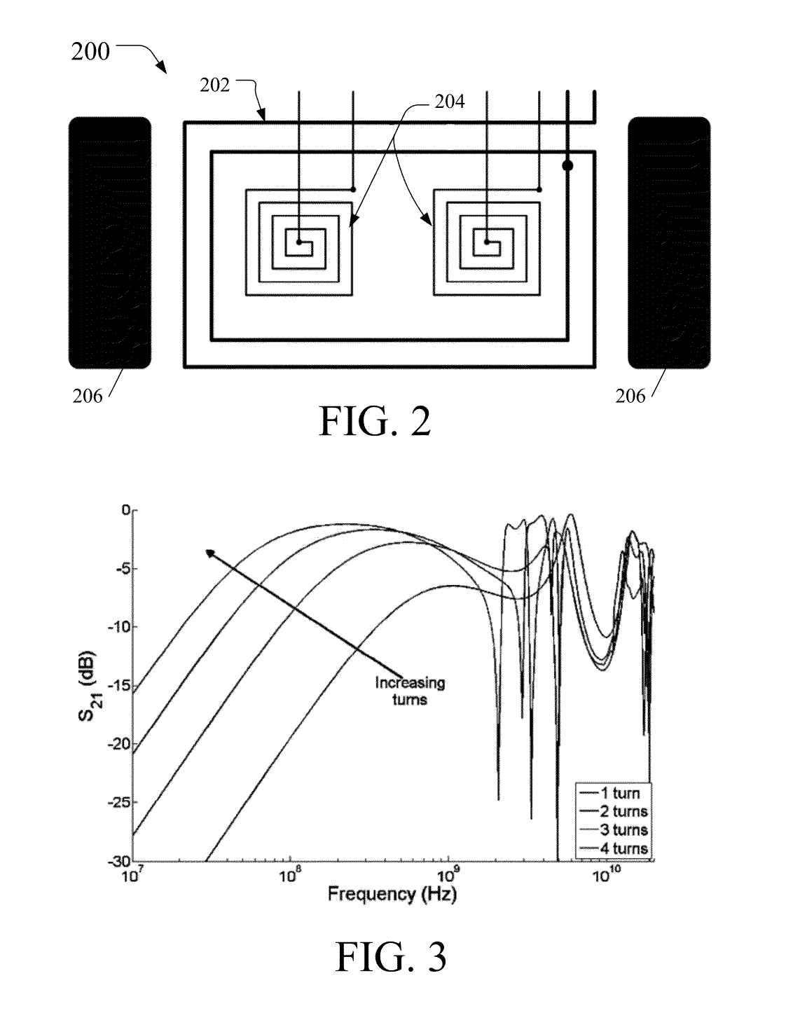

FIG. 2 illustrates a contactless connector design that incorporates inductive coupling coils for both power and data transfer in a nested design according to an embodiment of the subject matter described herein. Connector 200 includes a larger outer inductor 202 for power transfer surrounds one or more small inductors 204 used to transfer high-speed data. The mating side would have a similar or identical configuration. In one embodiment, for example, a pair of connectors 200 may be used to make a inductive connection. In the embodiment illustrated in FIG. 2, connector 200 also includes a pair of magnets 206. The magnets provide a way to mate the connector without the need for additional support structures and allow the connector to be pulled apart without the risk of causing damage to the device or connector.

Design Tradeoffs: Inductor Size.

Losses in an inductively coupled channel can generally be minimized by increasing the diameter of the inductor, increasing the number of turns in the inductor, and by minimizing the distance between the two inductors comprising a transformer.

For power transfer, minimizing this loss for a single frequency at which an AC signal can be efficiently produced, transferred, and rectified will produce the best results.

FIG. 3 is a graph illustrating the effect that increasing the number of turns of the power inductor has on the strength of the transferred signal and on the frequency at which peak coupling occurs. As can be seen in FIG. 3, by increasing the number of turns (and consequently the diameter of the inductor) the frequency at which peak coupling occurs decreases and the amount of power transferred increases. Depending on the application, the 31% increase in area occurred by adding a fourth turn may not justify the 0.5 dB improvement. By implementing the proper impedance matching for the power transfer, a resonant power transfer can be achieved and this can be used to design the peak efficiency. Flexibility in circuit design is achieved by co-designing the inductor and circuits in tandem.

For data transfer, the frequency range at which minimal loss occurs affects the shape of the received signal. An inductively coupled system is inherently a high-pass filter in the frequency domain, which act as a differentiator in the time domain. Thus, when a square wave composed of many high-frequency harmonics is transferred across the transformer, the frequency content is filtered resulting in a pulse at the output. The received signal's amplitude is dependent on the rise and fall time of the input signal and its decay time is dependent on the losses in the channel over the frequency spectrum.

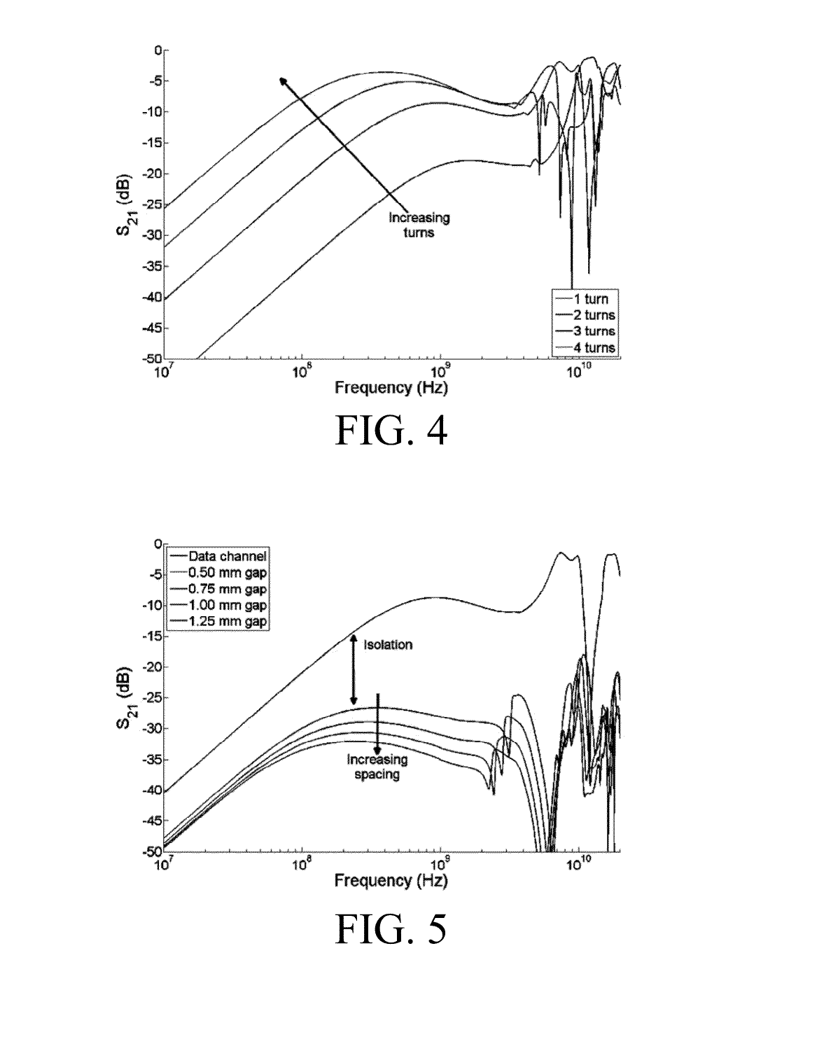

FIG. 4 is a graph illustrating the effect that increasing the number of turns of the data inductor has on the characteristics of the transferred signal. As can be seen in FIG. 4, the coupling coefficient of a transformer increases with the size and number of turns, but the frequency of the peak-coupling region decreases. For a high-speed non-return-to-zero (NRZ) signal, the increase in low-frequency content can produce a return-to-zero (RZ) pulse with a slowly decaying tail in the time domain, which can combine with the next data bit and produce inter-symbol interference (ISI). Therefore, high-speed signaling over a transformer becomes increasingly more difficult as the size of the inductors increases to the point where the ISI is no longer manageable, even with the application of equalization to the channel.

A connector according to one embodiment of the subject matter described herein utilizes one or more data transformers, sized such that the maximum designed signaling rate is achievable, surrounded by a single power transformer, sized to minimize data transfer interference and optimize power transfer based on the constraints of the mobile device. To realize the desired signaling rate may require co-design of the data transformer with the transceiver, such that the coupling coefficient of the transformer is high enough to provide a recoverable pulse to the receiver, but low enough to manage ISI at high-speeds.

Design Tradeoffs: Inductor Spacing.

To study the effect of crosstalk between the power and the data channel, the spacing between a 2-turn power inductor and a 2-turn data inductor was varied from 0.5 mm to 1.25 mm. The results of this simulation are shown in FIG. 5.

FIG. 5 is a graph illustrating the effect of crosstalk between the power and data channels of a connector according to an embodiment of the subject matter described herein at various spacings. For the data-to-power separation, only a single type of crosstalk is of interest, namely the component of the AC power signal that is transferred into the data channel. Crosstalk from the data channel into the power channel does not adversely affect the power channel performance. For this PCB design, 500 μm is the minimum allowable space between the data and power coils due to the size of the vias. This spacing, equivalent to approximately 38% of the data coil diameter, provides almost 20 dB or more of isolation to the data channel. If the receiver requires additional isolation, the separation between the data power channels can be increased at the expense of increased size in both the width and height of the connector.

Design Tradeoffs: Connector Gap.

Another parameter that has significant impact on the connector is the gap between the two mating connectors. In order to maintain a waterproof design, in one embodiment, the two connectors are coated in a thin layer of plastic.

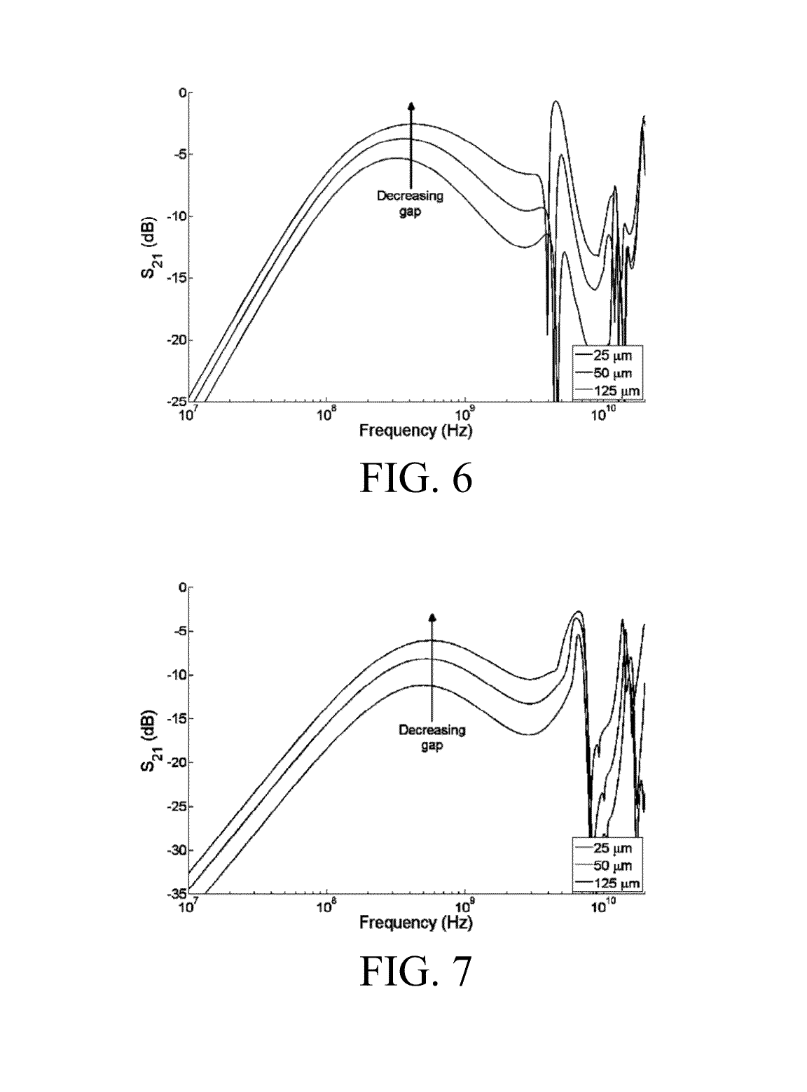

FIGS. 6 and 7 are graphs illustrating the effect of increasing the gap between the connectors for the power and data channels, respectively, of a contactless connector design for combining power delivery and signaling in inductively coupled connectors according to an embodiment of the subject matter described herein. The reduced signal output shown in FIG. 7 when compared to FIG. 6 is the result of the fact that the data transfer inductors used for these simulations are physically smaller than the power transfer inductor used for these simulations. As seen in FIGS. 6 and 7, the separation distance of the connectors has a large impact on the peak in the forward transfer coefficient, but does not shift its frequency. Thus, a connector with embedded circuitry would not have to be redesigned for a specific gap. However, a change in gap would require a receiver sensitive enough to recover the reduced amplitude data pulses and rectification circuitry efficient enough to operate with decreased power.

To enable a physical connection that can break away when stressed and to minimize the gap spacing, magnets are used to align the inductors and bring the two sides of the connector into as close proximity as possible. Thus far the magnets, such as magnets 106 shown in FIG. 1, have been neglected from this analysis; however, their presence has a minimal impact on the performance of the connector as a whole. Due to the nested design of the connector, the data channels are largely isolated from the magnets by the distance separating them. While the magnets produce some inductive loading on the power transformer, the effect is minimal and does not have a meaningful impact on the efficiency of power transfer.

The proposed connector is not limited to a single data channel, additional data channels can be added if the application requires it, such as in USB or HDMI. However, when adding additional channels, sufficient isolation between the channels is required such that they do not interfere with each other and cause unacceptable levels of crosstalk.

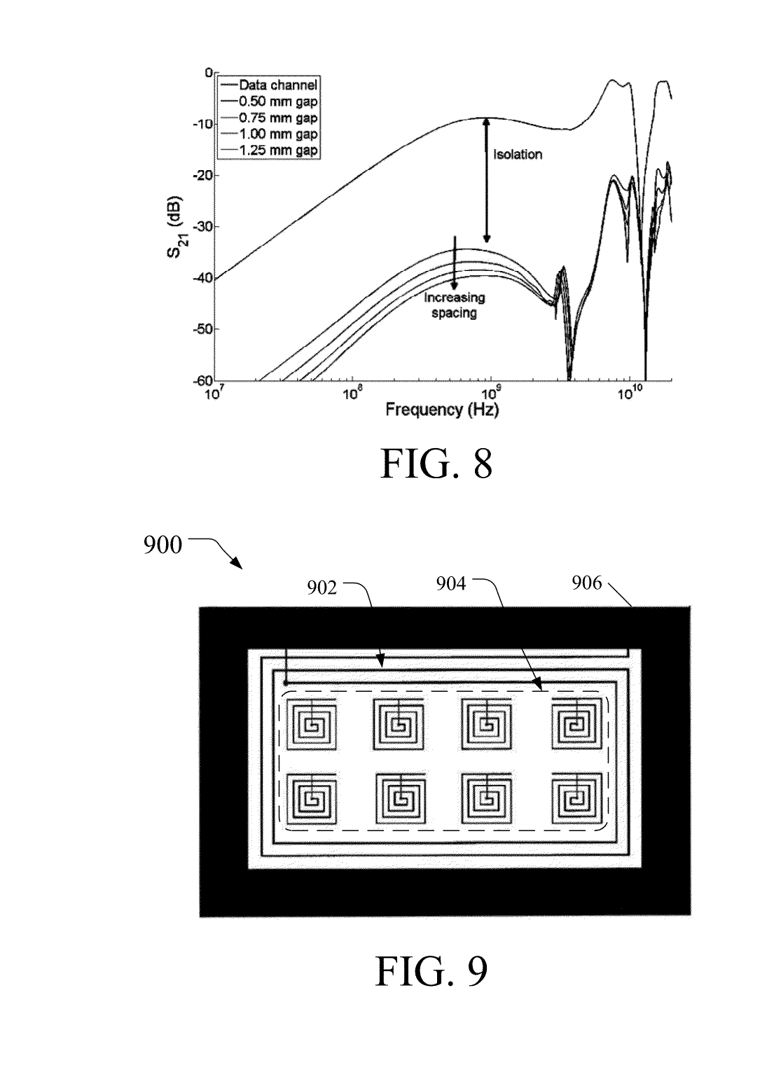

A connector composed of a pair of 2-turn data coils within a 2-turn power coil, similar to connector 200 in FIG. 2, was simulated while varying data-to-data spacing. The resulting crosstalk between the data channels is shown in FIG. 8.

FIG. 8 is a graph illustrating how data inductor/data inductor spacing affects crosstalk. FIG. 8 shows approximately 25 dB of isolation at the minimum spacing of 500 μm between the data coils. Similar to the power-to-data crosstalk, increasing the spacing between the coils results in increased isolation at the expense of increased connector size. Depending on the number of data channels and their configuration, an increase in data-to-data spacing may be acceptable. For example, a connector on the bottom of a mobile phone may have strict height restrictions due to the thickness of the phone, but relaxed width restrictions allowing the data channels to be sufficiently isolated.

Connectors according to embodiments described herein have the additional benefits of orientation independence and minimized pin count compared to conductive designs. For a typical high-speed conductive connector, differential signaling is used to cancel electromagnetic noise, resulting in the need for both a positive and a negative channel. In inductive coupling, a differential signal may be used to drive an inductor, resulting in a single transformer producing a differential output. Additionally, a common ground is not required on both sides of the proposed connector, further reducing the number of channels required when compared to a conductive connector.

FIGS. 9 through 11 are plan views of contactless connector designs for combining power delivery and signaling in inductively coupled connectors according to other embodiments of the subject matter described herein.

FIG. 9 is an plan view of a contactless connector design for combining power delivery and signaling in inductively coupled connectors according to another embodiment of the subject matter described herein. In the embodiment illustrated in FIG. 9, connector 900 includes a power inductor 902, multiple data inductors shown as group 904, and a magnetic perimeter 906. It should be noted that as the number of data inductors in group 904 increases, the size of power inductor 902 also increases, but that is an advantage for power inductors, because the larger the inductor, the more efficient the power transfer. In the embodiment illustrated in FIG. 9, there are eight data inductors, but any number of data inductors is contemplated.

Like connector 200 in FIG. 2, connector 900 can be connected in two orientations, 0 and 180 degrees relative to the mating connector. Orientation independence can be achieved through intelligent placement of the data channels in the proposed connector and by utilizing the phase property of the transformers. When the inductors comprising a transformer are out of phase, an input signal is output inverted compared to an in-phase transformer. In a multiple data channel connector, designing one channel to be the opposite phase of the rest will result in one channel producing an inverted result. By detecting this inversion, the receiver side can determine the orientation of the connector and redirect the data channels as necessary.

For example, in the embodiment illustrated in FIG. 9, it should be noted that the two data inductors farthest to the right of the figure are wound in the opposite direction from the other six data inductors. This means that the phase of the signals transmitted or received by the rightmost two inductors will be different from that of the signals received by the other six inductors. This information can be used by one side or the other of a connection—by the receiver, for example—to distinguish between the two possible orientations. In this manner, a user of a device having this kind of connector may position the connector in either position. Both will work correctly because the system can determine the orientation of the two connectors and adjust accordingly.

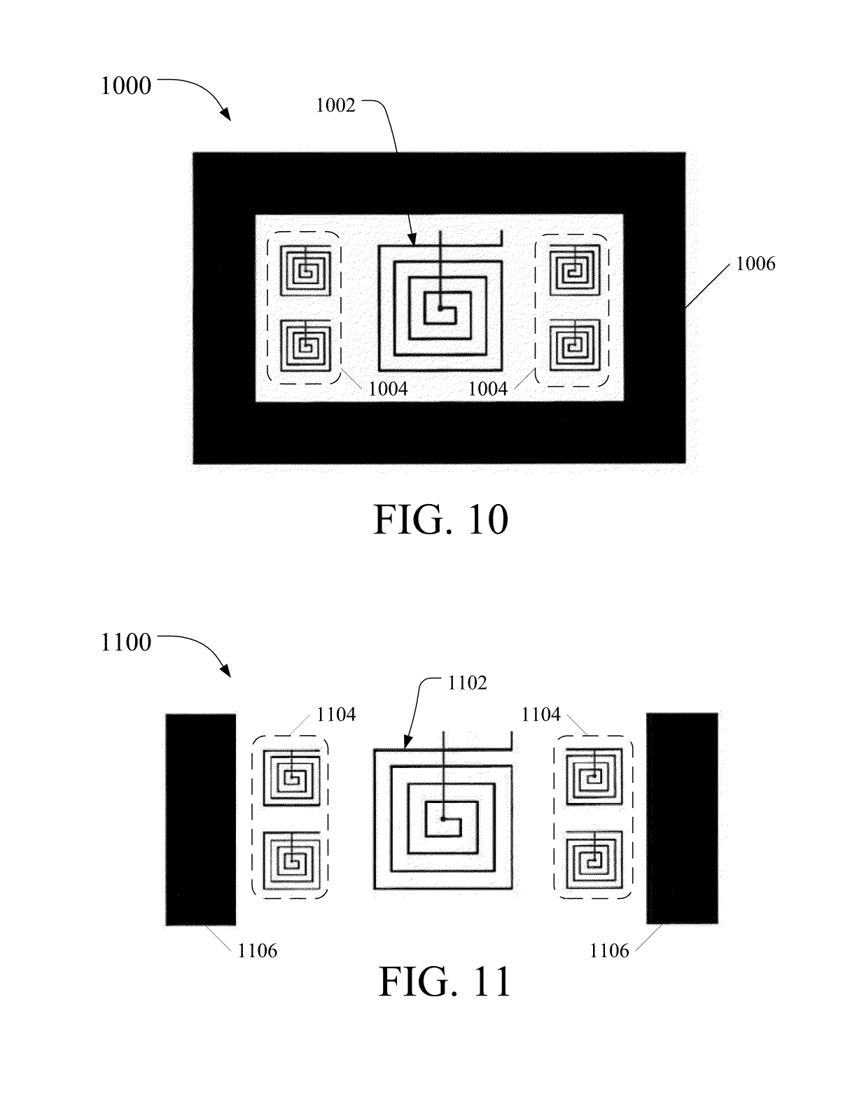

FIGS. 10 and 11 are plan views of a contactless connector design for combining power delivery and signaling in inductively coupled connectors according to other embodiments of the subject matter described herein. In the embodiment illustrated in FIG. 10, connector 1000 includes a power inductor 1002 and multiple data inductors 1004, all surrounded by a magnetic periphery 1006. In the embodiment illustrated in FIG. 11, connector 1100 also includes a power inductors 1102 and multiple data inductors 1104, but with magnetic regions 1106 on only two sides of connector 1100 rather than completely surrounding the inductors as in FIG. 10. In the embodiments illustrated in FIGS. 10 and 11, the data inductors are not within the loops of the power inductor, but are instead adjacent to the power inductor.

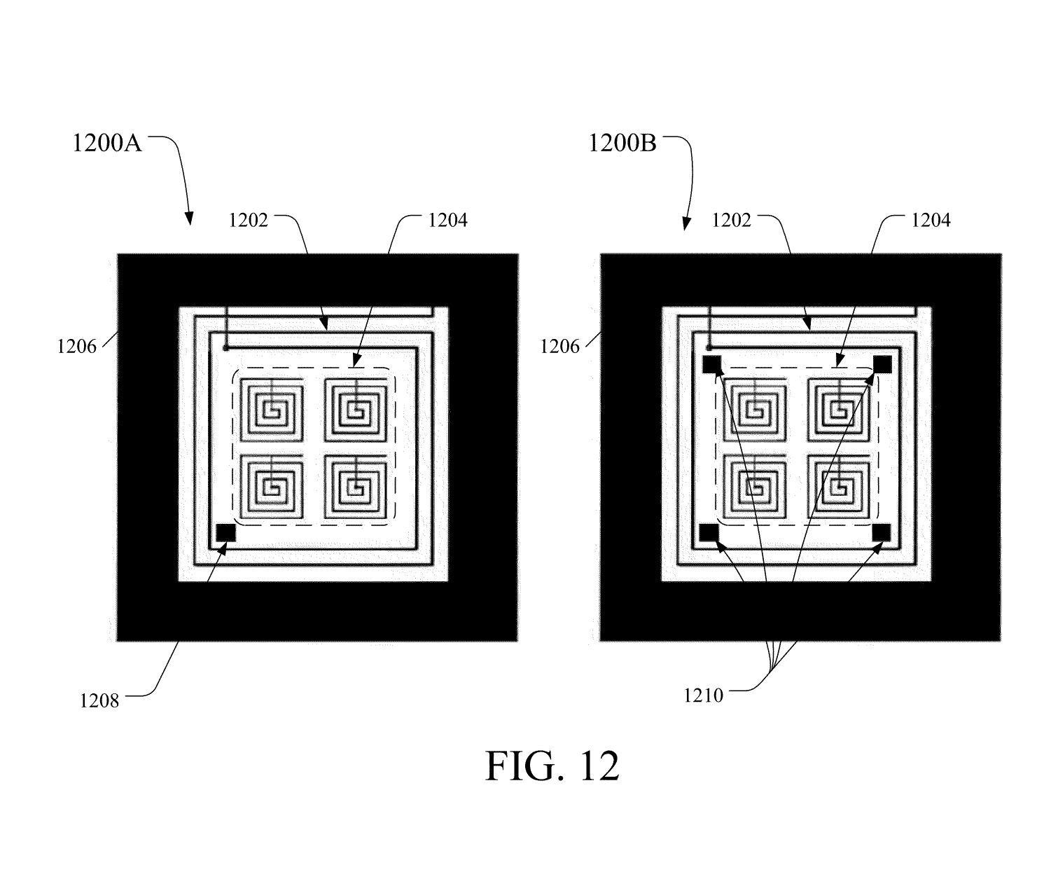

FIG. 12 is an plan view of a pair of connectors for combining power delivery and signaling in inductively coupled connectors according to another embodiment of the subject matter described herein. FIG. 12 illustrates a cable connector 1200A and its matching device connector 1200B. Both connectors include a power inductor 1202, multiple data inductors 1204, and a magnetic periphery 1206.

By placing a single capacitor or inductor off the axis of symmetry employed by the connector, it can be used to indicate the orientation of the connection. In the embodiment illustrated in FIG. 12, for example, cable connector 1200A includes an orientation indicator 1208 and device connector 1200B includes four orientation indicators 1210. In one embodiment, orientation indicators may be inductors, such that when connector 1200A is connected with connector 1200B, the orientation indication inductor 1208 on connector 1200A will inductively connect with one of the orientation indication inductors 1210 on connector 1200B. This orientation indicator can be utilized by the internal circuitry to switch the routing of the coupled data so that it goes to the correct circuitry. Since the inductor used for power transmission can be placed around the exterior of the connector or centered in the connector, its orientation does not affect power transfer. Internal receiving circuitry can also be designed to accept either the positive or negative pulses produced by transformers in phase or out of phase. In this manner the device can determine the orientation of connector 1200A relative to mated connector 1200B, and map the data signals being transferred across data inductors 1208 accordingly. In an alternative embodiment, capacitors may be used instead of inductors as orientation indicators 1208.

### Prototype Headphone Connector

A nested inductive connector, consisting of a single power channel and one or more data channels, is proposed as a replacement for legacy conductive connectors in mobile devices. The advantages include minimized volume utilization in the mobile device, waterproofing, orientation independence, and resistance to stress through a breakaway mechanism.

An analysis of the relevant parameters of the connector design and a prototype of the proposed connector, designed in IBM's 0.13 μm process as a replacement for the TRS headphone jack, are presented. The prototype design supports 16-bit 44.1 kHz stereo audio at 1.41 Mbps, is powered inductively, and outputs 12 mW power on each 32Ω load.

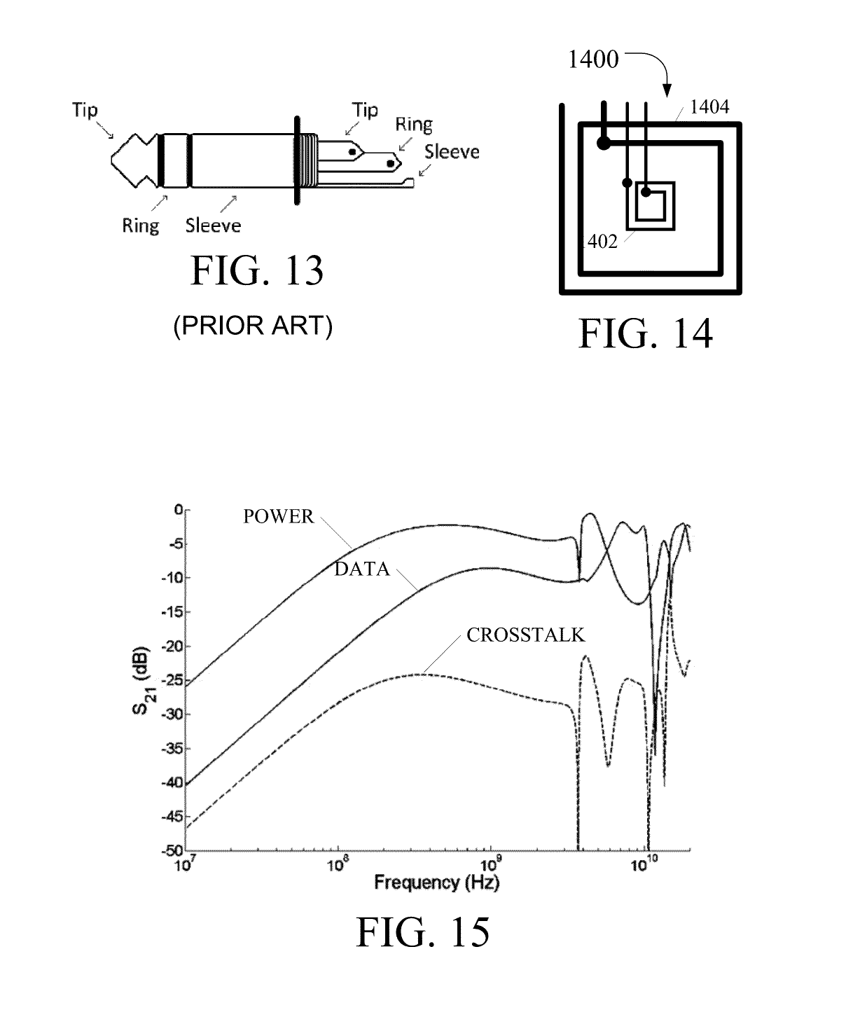

FIG. 13 shows a standard TRS headphone plug. The TRS connector, which has remained virtually unchanged for over 100 years, is widely used for analog signaling and consists of a 3.5 mm plug with three conductive sections: left channel audio (tip), right channel audio (ring), and ground (sleeve), as seen in FIG. 13. This simple design does have some drawbacks; the connector requires a large internal volume in the device for insertion, and there is potential for damage to the connector and device when the connection is stressed. The lack of waterproofing can also be an issue as the cavity provides a path for water to flow into the device, potentially causing damage to the device.

As a working prototype of the fully inductive connector, a replacement for the standard TRS headphone jack found in most mobile devices was designed. The replacement connector, designed to be built using a standard PCB process, has an area without magnets that closely mimics the size of the TRS connector. An example connector is shown in FIG. 14.

FIG. 14 illustrates an exemplary contactless connector design for combining power delivery and signaling in inductively coupled connectors according to an embodiment of the subject matter described herein. In the embodiment illustrated in FIG. 14, connector 1400 includes a single two-turn data inductor 1402 1.32 mm in diameter, which is nested within a two-turn power inductor 1404 3.61 mm in diameter. The data channel exhibits a minimum of approximately 10 dB of forward loss, while for the power channel the loss is approximately 3 dB, as illustrated in FIG. 15.

FIG. 15 is a graph illustrating the performance of connector 1400 over a range of frequencies. As can be seen in FIG. 15, using a separation between the inductors of 25 μm, crosstalk between the channels is acceptably low.

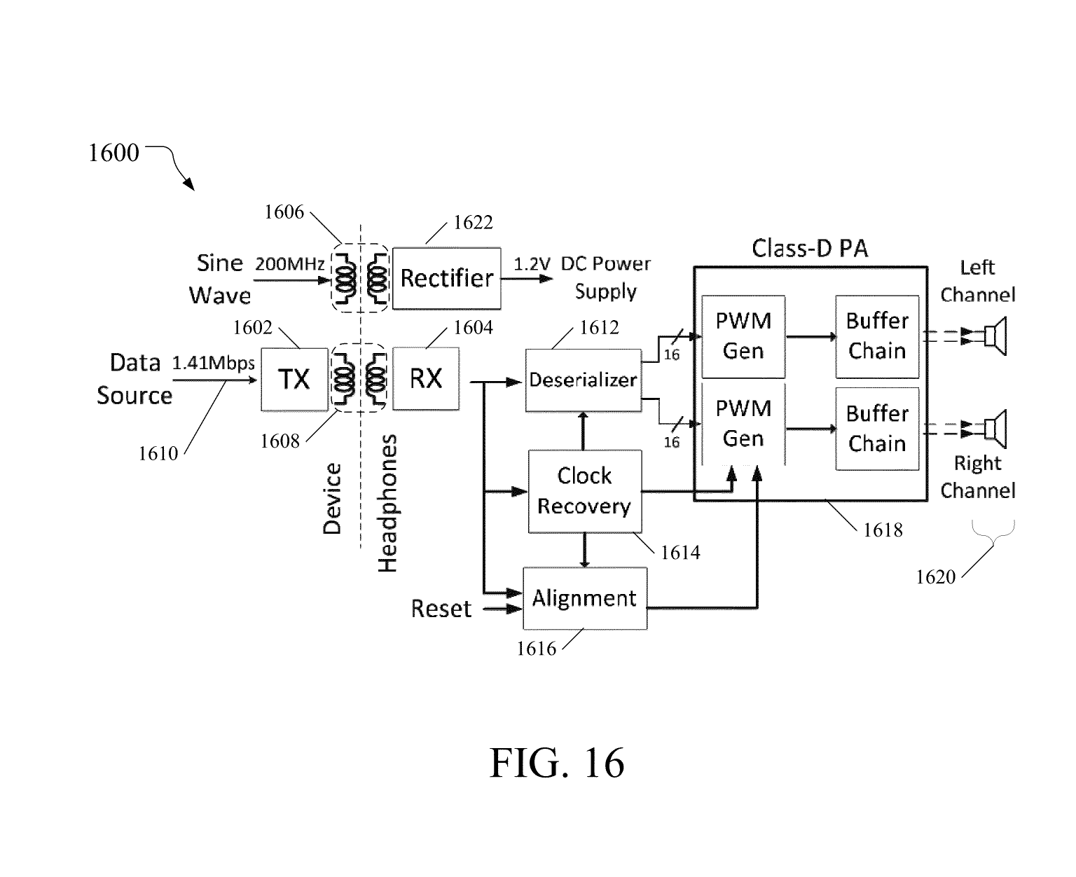

FIG. 16 is a block diagram illustrating an exemplary headphone circuit using a connector such as connector 1400 according to an embodiment of the subject matter described herein. In the embodiment illustrated in FIG. 16, circuit 1600 includes a current-mode driver 1602 on the device side and a pulse receiver 1604 on the headphone side, powered by the device through the power transformer 1606 formed by the pair of power inductors in the mated connectors, were designed in IBM's 0.13 μm process. Since the data rate required to send audio signals is relatively slow, the connector structure can utilize a single data transformer 1608 formed by the pair of data inductors in the mated connectors to serially transmit the left and right audio channels.

Processing of audio data from the mobile device consists of three main steps; sending sampled digital audio data across the high-pass inductive data channel 1610, recovery of the data on the receiver side, e.g., using deserializer 1612, clock recovery module 1614, and alignment module 1616, and conversion of the digital data to an amplified analog audio signal to drive the 32Ω load. In the embodiment illustrated in FIG. 16, circuit 1600 includes a class D power amplifier 1618, which receives 16-bit left and right channel data uses that data to generate a pulse width modulated (PWM) signal that is sent to a buffer chain for output to left and right channel speakers 1620. The power recovered from the power transformer is converted from AC to DC power using a two-stage differential-drive CMOS rectifier 1622 [6], producing a stable 1.2 V supply with a peak output current of 50 mA.

In a typical inductive transceiver, non-return to zero (NRZ) data is input to a differential driver, which steers the current swing in the primary inductor, creating an alternating magnetic field, which induces current pulses in the secondary inductor. A differential receiver then senses the current pulses, converts them into amplified voltage pulses, and latches them back to the original NRZ data.

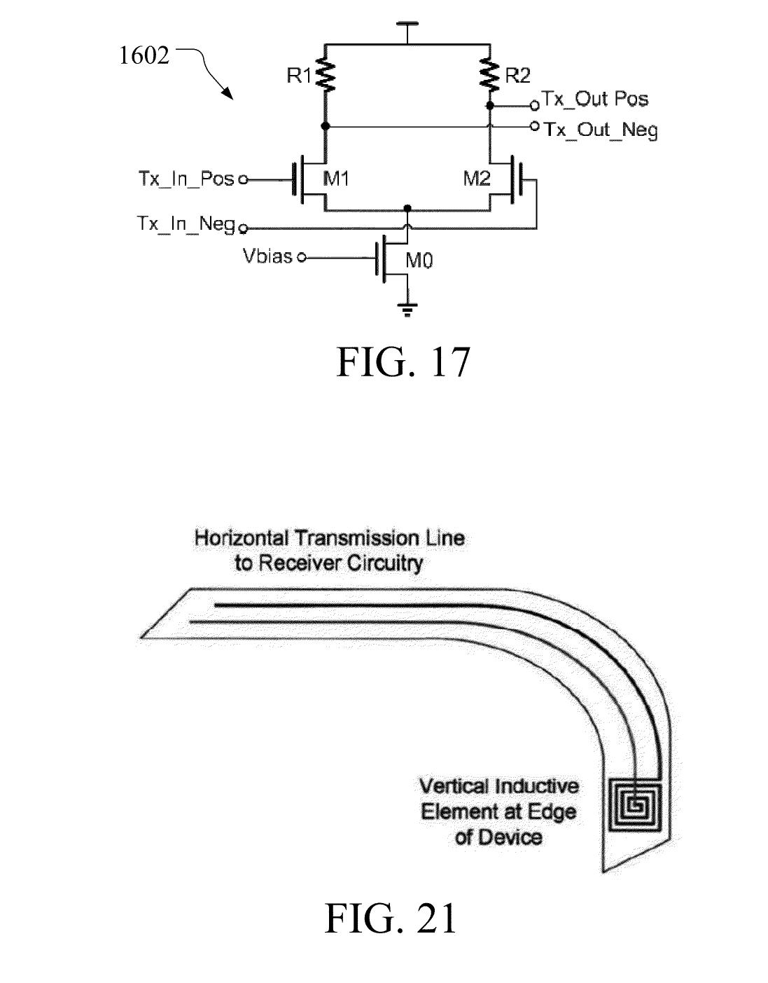

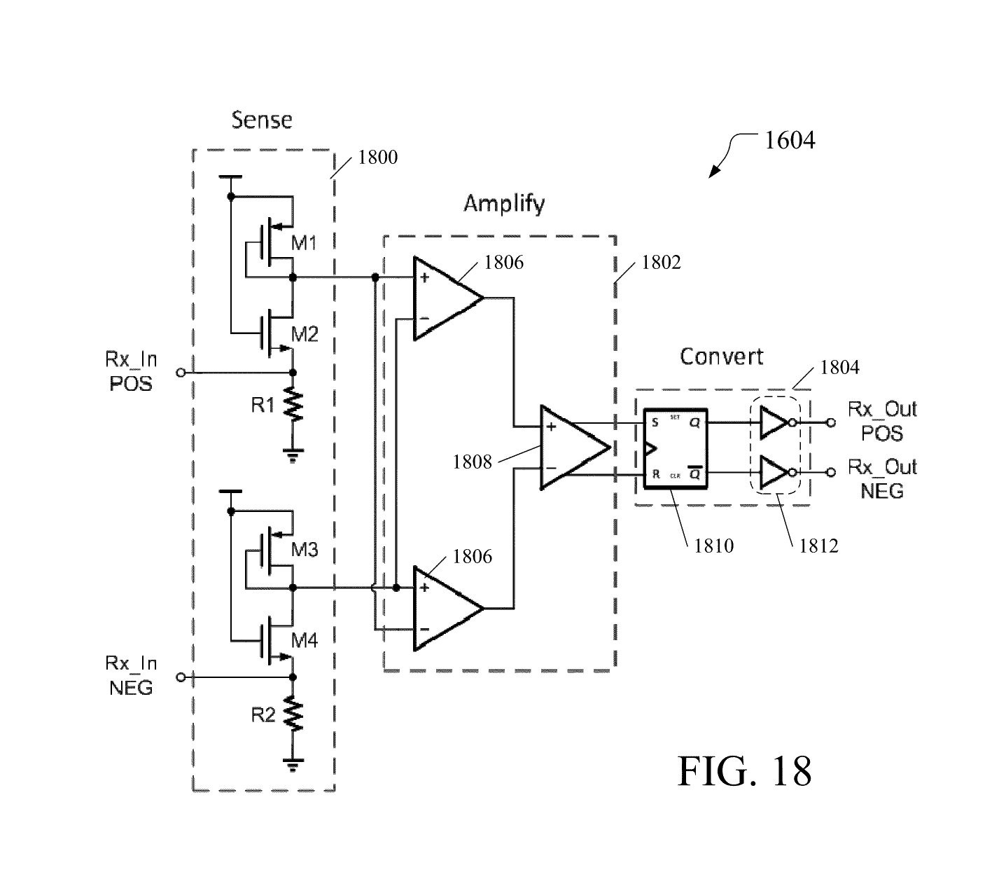

FIG. 17 is a circuit diagram illustrating an exemplary differential driver suitable for use as current-mode driver 1602, due to its ability to generate fast rising and falling edges with a balanced duty cycle. In the embodiment illustrated in FIG. 17, driver 1602 includes transistors M0, M1, and M2 along with pull-up resistors R1 and R2. For our prototype system, for example, the data rate required for stereo audio is slow enough that equalization is not implemented. However, for an application requiring multi-Gbps data, it may be necessary to implement driver-side equalization to minimize ISI caused by the relatively large transformers on the PCB [7]. To recover the AC pulse signal, a low swing complementary pulse receiver was implemented, illustrated in FIG. 18 [8].

FIG. 18 is a circuit diagram illustrating an exemplary differential receiver suitable for use as pulse receiver 1604. In the embodiment illustrated in FIG. 18, receiver 1604 includes a sense stage 1800, an amplify stage 1802, and a convert stage 1804. In the embodiment illustrated in FIG. 18, sense stage 1800 uses a common gate single stage amplifier for each input (M1, M2, and R1 for the positive input terminal and M3, M4, and R2 for the negative input terminal) due to its relatively low impedance. In our design, sense stage 1800 was co-designed with the amplify stage 1802 to achieve a high gain with relatively wide bandwidth. In the embodiment illustrated in FIG. 18, amplify stage 1802 includes a pair of op-amps 1806 that feed a differential op-amp 1808, but other circuit topologies may be used. In the embodiment illustrated in FIG. 18, convert stage 1804 includes an RS latch 1810 that latches the incoming data, restoring it back to NRZ, and buffers 1812 for the next stage of the system, but other circuit topologies may be used.

Referring back to FIG. 16, the receiver portion of circuit 1600 recovers two serialized 16-bit 44.1 kHz digital audio signals, which are then deserialized by a Serial-In Parallel-Out (SIPO) circuit 1612. To minimize the size of the connector, the clock signals required for both SIPO and power amplification are recovered from the audio signals rather than transmitted through a second data transformer. In the embodiment illustrated in FIG. 16, clock recovery circuit 1614 and alignment circuit 1616 are used for this purpose.

In the embodiment illustrated in FIG. 16, once the digital audio data is de-serialized, it is amplified by digital Class-D power amplifier (PA) 1618 such that it can drive the 32Ω headphone load 1620. The PA generates a pulse-width modulated (PWM) signal by sampling the input audio data using the uniform process, which despite its high total harmonic distortion provides less power consumption than algorithmic-based processes that rely on DSP blocks [9].

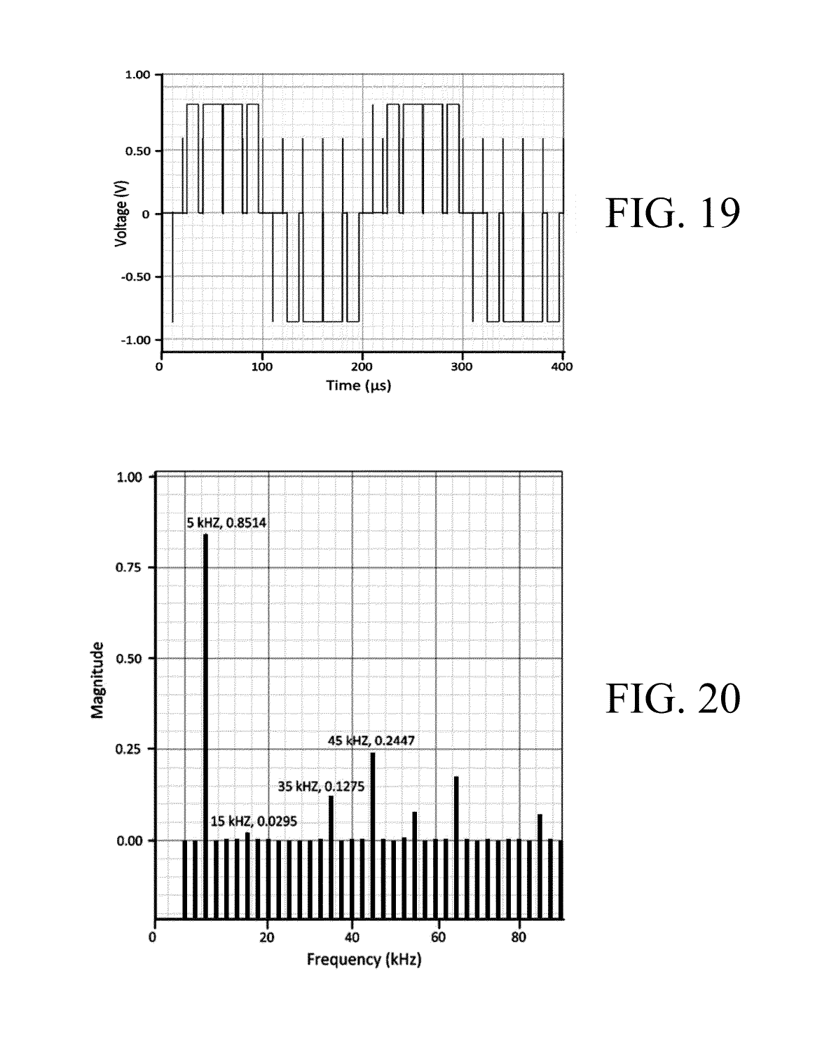

FIG. 19 is a waveform showing an example PWM output for a 5 kHz tone. The complete design was simulated using a single tone of 5 kHz, which is sampled at 44.1 kHz with a resolution of 16-bits. The transient simulation results presented in FIG. 19 shows the PWM output voltage across the 32Ω load.

FIG. 20 is a graph showing the corresponding frequency spectrum for the PWM waveform shown in FIG. 19. The 5 kHz tone is recovered, but distortion at the harmonics of the input frequency is also present. This distortion can be mitigated, however, by implementing an algorithm based PWM generation process instead of uniform sampling and implementing a feedback loop in the power amplifier. Table 1, below, shows the simulated performance of the connector and headphone circuits.

TABLE 1
Inductive headphone driver performance metrics

| Technology | | IBM 0.13 μm CMOS | |
|---|---|---|---|
| Area | | 1 mm × 1 mm | |
| Power | TX | 3 | mW |
| Dissipation | RX | 1 | mW |
| | Deserializer | 200 | μW |
| | Alignment | 100 | μW |
| | Clock Recovery | 400 | μW |
| | PWM Generator | 400 | μW |
| | Output Buffer (include load) | 50 | mW |

| | | |
|---|---|---|
| Max Data Rate | 2 | Gbps |

A connector composed of inductors of different sizes encased within plastic (or some other material which prevent a direct conductive contact) used to contactlessly transfer high-speed digital data and power has been described. The connector can include magnets at the edges or around the whole periphery to bring the inductors on either side of the connector into close proximity to create a transformer. The inductors used for digital data transmission can be placed in the same plane side by side with the inductor used to transfer power or wholly within the inductor used to transfer power. Additionally the inductors used in high-speed digital data transmission can be replaced by optical interconnects.

FIG. 21 illustrates an embodiment in which the inductors on either side of contactless connector could be created on flexible printed circuit board (PCB), thereby allowing signals to seamlessly transfer from a vertical orientation to a horizontal orientation or vice versa by bending the flexible PCB. Signals can be transferred inductively in a horizontal orientation then routed using transmission lines to receiver circuitry in a vertical orientation. This allows for a simple and inexpensive means to transition signals, for example, from the vertical bottom of a device to the horizontal back of a device.

The embodiments of a contactless connector design for combining power delivery and signaling in inductively coupled connectors described above use data inductors that are smaller than the power inductor, but the subject matter described herein is not so limited. In an alternative embodiment, for example, the data inductors may be the same size (or even larger than) the power inductor. By utilizing multi-bit fractional equalization in tandem with intelligent transformer sizing the power used by inductive data transfer can be minimized. When using current mode signaling. reducing the amount of current output onto the inductive channel directly reduces the power consumption of the driver circuitry. Larger diameter transformers with more turns inherently couple more signal than smaller ones, allowing for less current to be output on the channel and thus less power to be consumed when compared to smaller transformers. However. due to the inherent slow decay of the pulse produced by large transformers, their maximum signaling speed is limited. Through the use of driver-side multi-bit fractional (sub-bit) equalization, the maximum signaling speed achievable with larger transformers can be increased by reducing the time it takes for the tail of the coupled pulse to return to the zero state. The use of multi-bit fractional equalization can also reduce the power consumption of the driver circuitry if the equalization required is aggressive enough. By selecting transformer sizes larger than may be required (but still within connector size constraints) and thus forcing the use of aggressive multi-bit fractional equalization, the overall power consumption of the inductive driver can be reduced when compared to an optimally sized transformer without equalization. In other words, sizing the data inductors such that they require aggressive equalization can result in driver-side power savings.

Cables consisting of a standard conductive interface, such as those employed by USB, Firewire, HDMI, etc, on one end and an inductive connector as described above on the other can be created. The inductive connector can be used to easily attach a computer or other device without affecting the protocol of data transmission used. A cable consisting of inductive connections as described above on both ends of the cable can also be created. When two transformers are placed in series with each other, additional inter-symbol interference (ISI) is produced due to the second transformer. This ISI can be minimized through the use of multi-bit fractional equalization at the driver side, thus allowing for high-speed digital data transmission over channels consisting of two transformers and zero or more transmission lines.

In embodiments where a magnet is used to bring the inductors on either side of the connector into close proximity, that magnet could potentially be used to transfer a common ground between both sides of the connector.

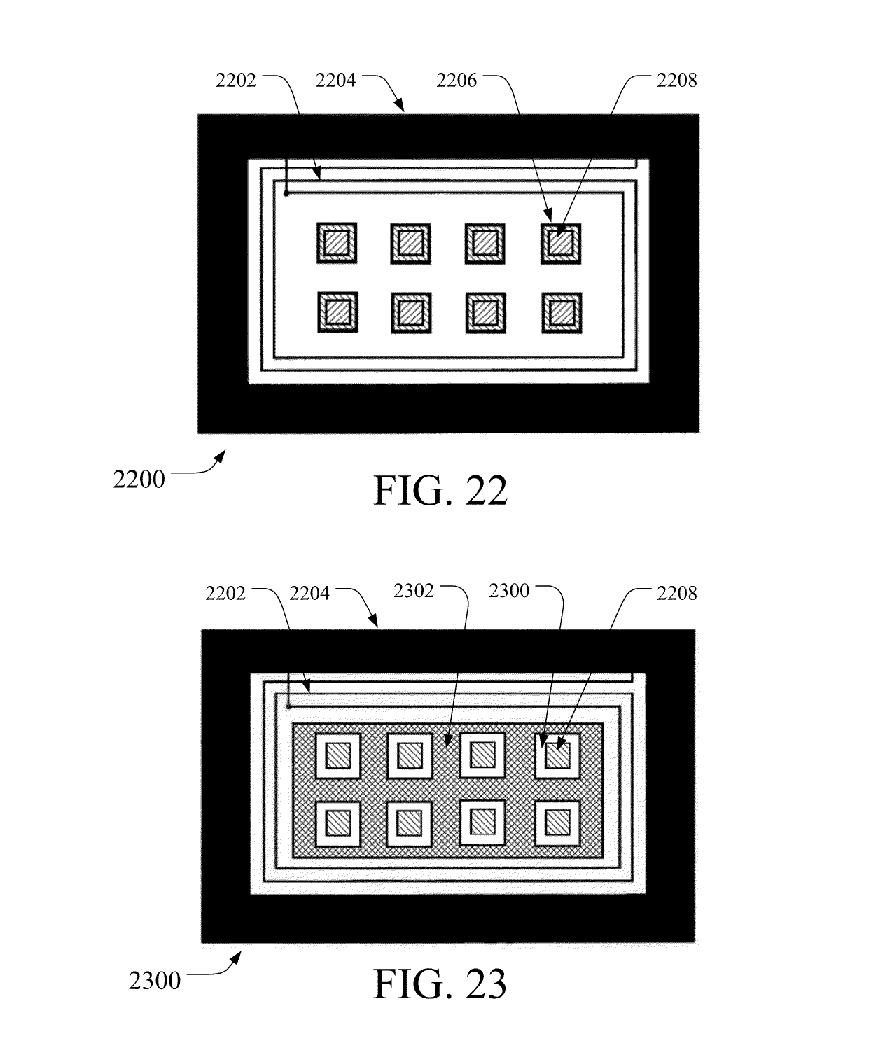

The embodiments of a contactless connector design for combining power delivery and signaling in inductively coupled connectors described above use inductors for data transfer, but the subject matter described herein is not so limited. In one embodiment, for example, a connector may use an inductive connection to transfer power but use an optical connection to transfer data. An example connector pair is illustrated in FIG. 22.

FIGS. 22 and 23 are plan views of contactless connector designs for combining power delivery and signaling in inductively coupled connectors according to other embodiments of the subject matter described herein.

In the embodiment illustrated in FIG. 22, connector 2200 includes a power inductor 2202 for transferring power inductively to the opposite connector in a mated pair. In the embodiment illustrated in FIG. 22, connector 2200 includes a magnetic perimeter 2204, but alternative embodiments may exclude this feature. Connector 2200 illustrates an embodiment that includes a set of protruding optical wells 2206 that would slightly insert into corresponding recessed connection sites on the other side of the connector to ensure proper alignment and to provide some optical isolation from other optical wells 2206. Each optical well 2206 is home to an optical connection 2208, which may be a semiconductor laser or other component of an optical connector.

In the embodiment illustrated in FIG. 23, connector 2300, like connector 2200, includes a power inductor 2202, an optional magnetic perimeter 2204, and multiple optical connections 2208. Rather than a protruding optical well 2206 such as used in connector 2200, however, the optical connections 2208 do not protrude but are instead all part of a planar surface 2300 that includes an optical mask 2302 to optically separate the optical connections from each other.

Advantages of the described Inductive and inductive/optical connectors include:

Zero Insertion Force.

The connector is non-contacting and thus more resistant to mechanical failures. By using magnets to bring the inductors into close proximity. the connection can accidentally be severed without damage to the connector. By encasing the inductors within a waterproof material (such as plastic). both sides of the connector can be made waterproof.

Low Profile.

Connector space on both the device and cable is minimized by using very thin inductors and magnets to hold the two sides of the connector within close proximity and minimizing the male portion of the connector that inserts into the female portion. This reduces space required by the connector in a device. Differential signals can be coupled over a single set of inductors comprising a transformer, rather than two separate conductive pins.

Low Cost.

An inexpensive flex PCB can be used to create the inductors on both sides of the connector allowing costly mechanical connectors to be replaced.

Potential uses of this technology include: a waterproof interface for power and high-speed data in mobile & non-mobile devices; potential replacement for USB, Firewire, HDMI, etc., connectors without changing the underlying protocol; replacement for dock connectors used in mobile devices; potential replacement for the standard headphone jack (TS/TRS/TRRS connector), especially for mobile devices where waterproofing is beneficial.

Yet another application of a contactless connector design for combining power delivery and signaling in inductively coupled connectors is to incorporate data transfer capability into near-field charging pads.

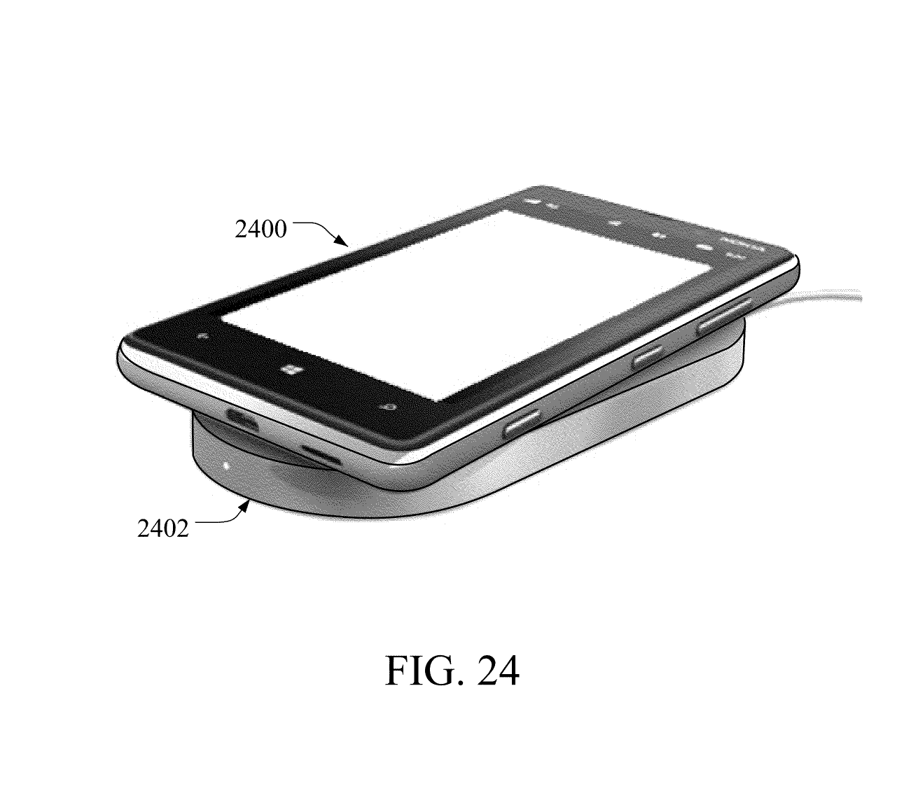

FIG. 24 illustrates an example mobile device 2400 resting on a charging pad 2402, each of which including a contactless connector design for combining power delivery and signaling in inductively coupled connectors according to an embodiment of the subject matter described herein. It would be desirable to incorporate fast data transfer for a number of potential applications, such as data backup or connecting with a high definition TV (WiFi cannot support HDMI data rates). To enable these high speed (multi-Gbps) applications, two approaches that can be used singly or in combination are presented.

The first approach is to place an irregular array of small inductors across both the charging pad and back of the phone. The pattern of dithering on each plane may be the same or different, but the idea is to ensure that at least one opposing pair of inductors is sufficiently aligned to ensure data transfer. In our own past work, we have found that we can have a misalignment of up to one inductor radius and still can perform data transfer [Xu05].

In one embodiment, an electrical connector part includes a first mating connector face having disposed thereon a first set of inductors and a mechanical interface that is configured to maintain the first mating connector face in closely spaced apart relation to a second mating conductor face having disposed thereon a second set of inductors. The mechanical interface is designed to prevent DC coupling and provide inductive AC coupling between at least one pair of inductors comprising one inductor from the first plurality of inductors and one inductor from the second plurality of inductors. Each set of inductors includes a power inductor for transmitting power between the first and second mating connector faces and at least one data inductor for transmitting data between the first and second mating connector faces. The patterns of the sets of inductors provide inductive AC coupling between at least one pair of inductors, one on each mating connector face, regardless of the orientation of the first and second mating connector faces relative to each other.

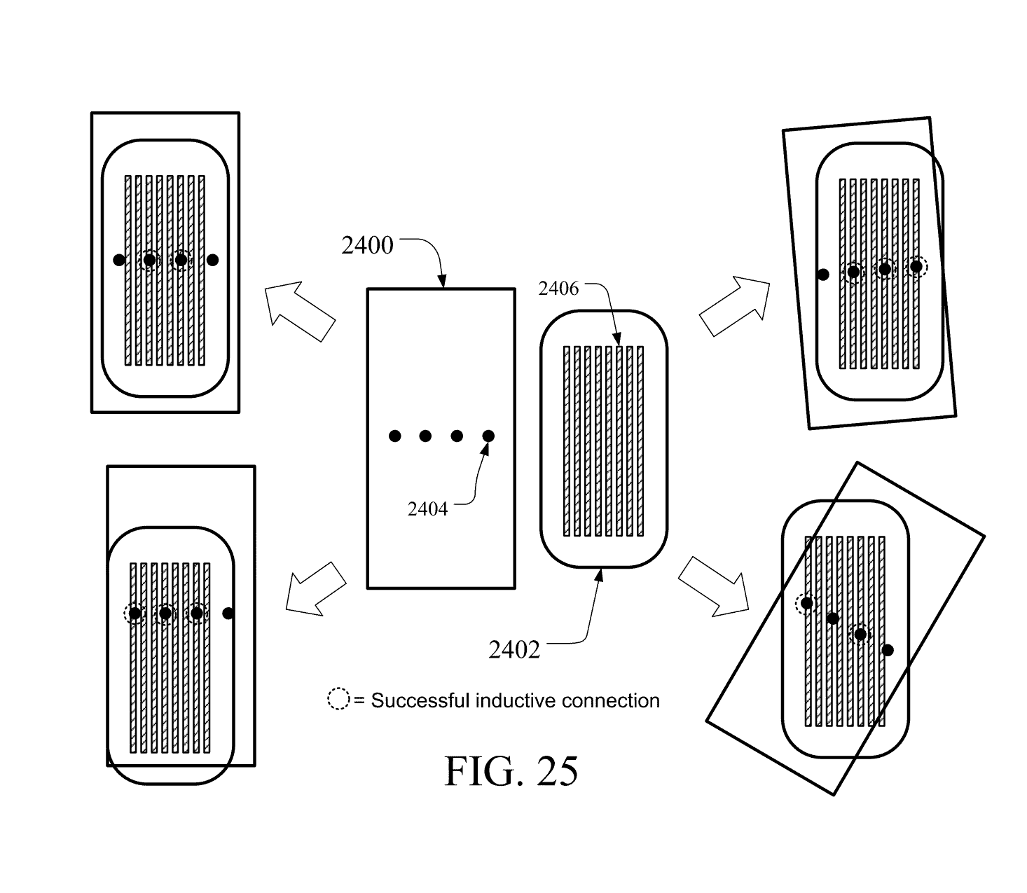

FIG. 25 illustrates an exemplary dithering pattern that may be employed by a mobile device and charging pad for combining power delivery and signaling in inductively coupled connectors according to embodiments of the subject matter described herein. In the embodiment illustrated in FIG. 25, the pairs of patterns represent placement of inductors on device 2400 and pad 2402, but the patterns may be swapped between device and pad. The patterns shown in FIG. 25 are illustrative and not limiting: any pair of patterns that cause at least one data inductor on the device to line up with at least one data inductor on the charging pad may be used. The two patterns that make up a pattern pair may be the same or different from each other.

The pair of patterns shown in the center of FIG. 25 are surrounded by figures that represent example possible relative positions between device and pad after a user has placed device 2400 onto pad 2402. When a device inductor 2404 lines up with a pad inductor 2406 (or is sufficiently close to enable a successful inductive connection between device 2400 and pad 2402), this connection is marked in FIG. 25 by a dotted circle. FIG. 25 illustrates the point that for a wide range of relative positions and rotations, at least one inductive connection is very likely to be made. Other pairs of patterns include, but are not limited to: pairs of grids, where the spacing of the grid on one side is different than the spacing of the grid on the other side; designs that have regular spacing on one side and a gradient spacing (e.g., spacing that changes pitch across at least one dimension); designs that use square grids; designs that use radial grids; designs that use randomly placed inductors on one side and regularly spaced inductors on the other; and any other design that achieves the same result.

In an alternative embodiment, device 2400 and pad 2402 may include some means to limit or severely constrain the variation in relative position and orientation of the two parts. Example means include, but are not limited to, magnets, depressions, indentations, slots, guides, alignment tabs or other structures, and so on.

In one embodiment, the mechanical interface may include an electrically insulating layer to prevent electrical connection between the two sets of inductors. This layer may be an insulating material or it may be an air gap created by mechanical structures that prevent the two sets of inductors from physically touching but allow them to be close enough for successful inductive transfer.

Although not shown in FIG. 25, in one embodiment, device 2400 and pad 2402 may also include one or more power inductors. For example, both device 2400 and pad 2402 may include a large power inductor running around the perimeter of their respective bodies, such that regardless of the relative orientation of device 2400 to pad 2402, there is enough inductive coupling to provide adequate power (which is easier to guarantee the larger the power inductor.)

The second approach would be use large inductors for both power and data transfer, and to employ multi-tap equalization so as to remove the large amount of ISI that would result from doing high speed data transfer through large inductors [7]. Pulse signaling in a sub-millimeter pitch inductively coupled system is inherent due to the high-pass filter response of the transformer in the frequency domain that acts as a differentiator in the time domain.

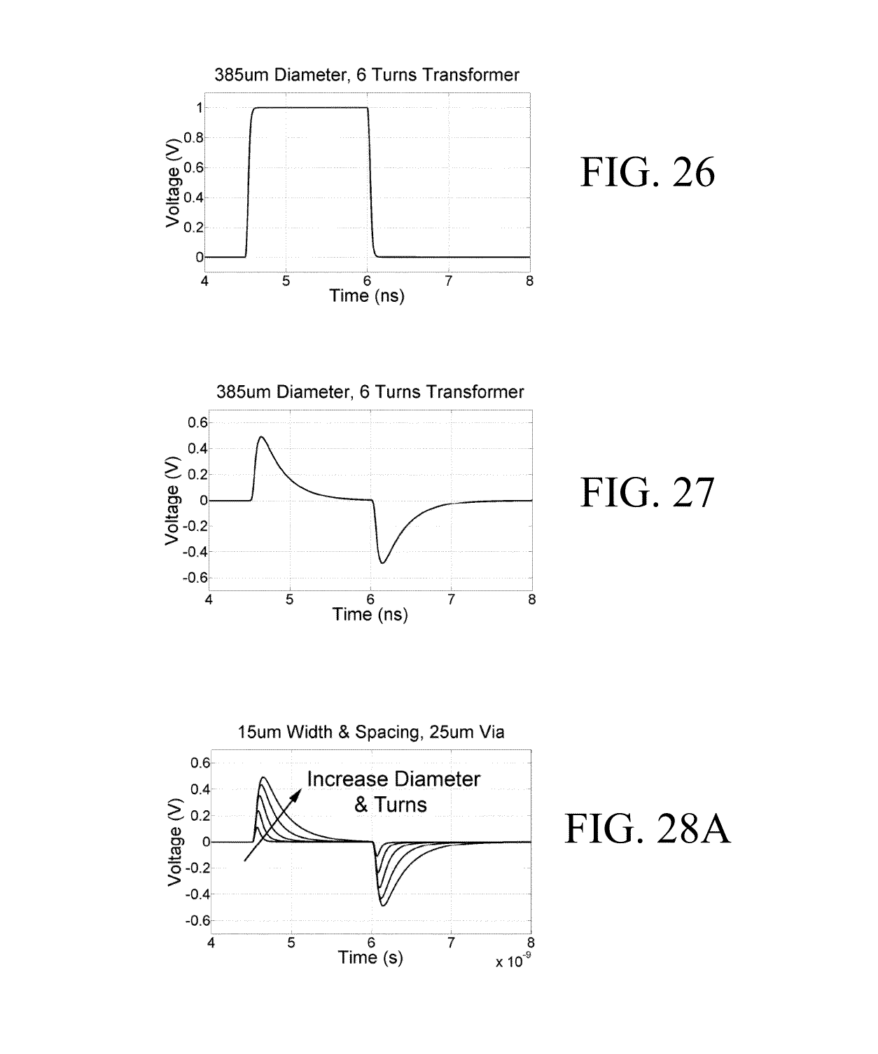

FIGS. 26 and 27 are plots of an example input signal into a transformer and the output of the transformer, respectively. FIG. 26 is a waveform of a typical binary non-return-to-zero (NRZ) signal, which is input into a transformer. FIG. 27 is a waveform showing the output of the transformer. As can be seen in FIG. 27, the square wave input into a transformer produces output pulses with a magnitude directly related to the rise or fall time of the NRZ edge and a decay time dependent on the coupling of the transformer.

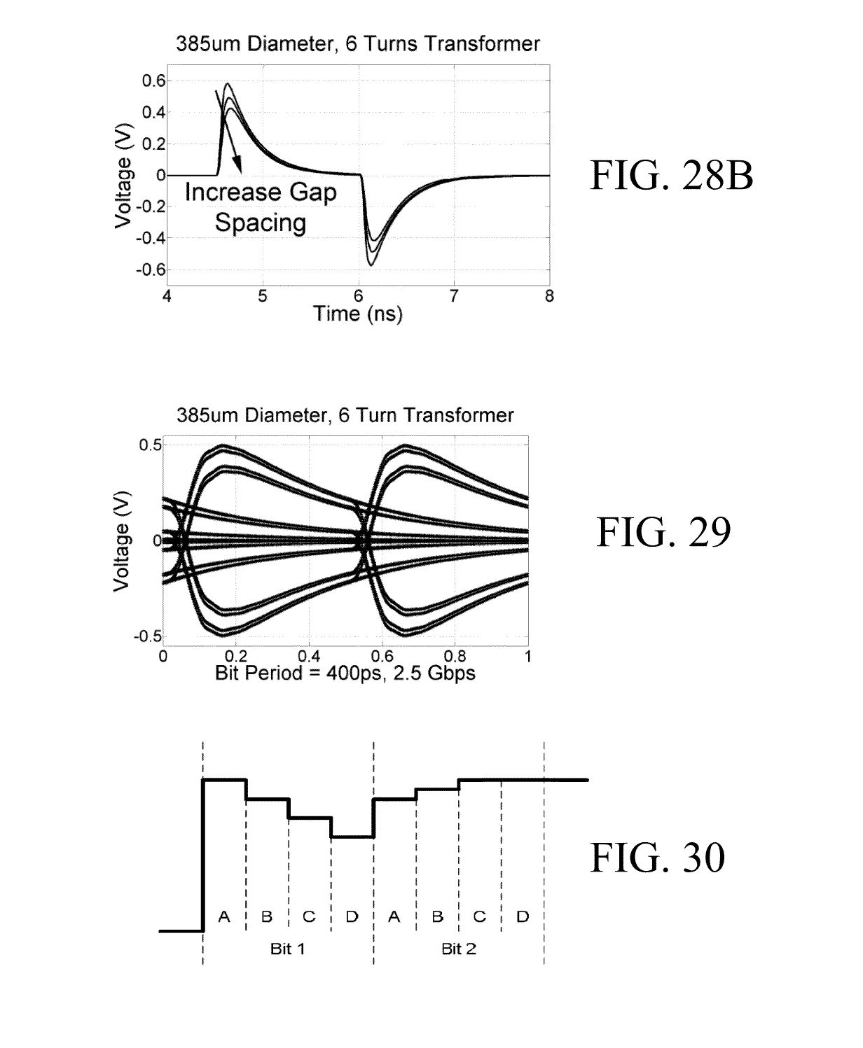

FIG. 28A is a plot showing how the shape of the output pulse changes as the transformer characteristics change. As can be seen in FIG. 28A, as the inductance of the transformer increases due to an increase in the number of turns and/or the overall diameter, the magnitude of the coupled signal increases along with the natural decay time. This effect can be seen in the frequency and time domain as the outer diameter of a transformer with 15 μm width and spacing lines and a 25 μm via is varied from 145 μm (2 turns) to 385 μm (6 turns).

When a transformer is placed in a lossy transmission line, such as in a backplane or a connector with stubs, the transmission line acts as a low-pass filter in the frequency domain, while the transformer acts as a high-pass filter. The result in the time domain for the complete channel is a reduction in the peak magnitude of the pulse, while the slow decay time of the pulse is unchanged.

FIG. 28B is a plot showing the effect of increased gap between the two inductors on the shape of the output pulse. As can be seen in FIG. 28B, as the gap spacing between inductors is increased, the magnitude of the coupled signal is decreased, while the natural decay of the pulse remains the same. Therefore larger diameter transformers with more turns are required to successfully transmit signals over larger gaps and longer transmission lines.

FIG. 29 is an eye diagram showing the effect of increased decay times, i.e., inter-symbol interference, or ISI. This increase in transformer size leads directly to slower signaling data rates to avoid the ISI caused by the slow decay of the pulse's tail such as is shown in FIG. 29. A transformer's size must be independent from its maximum signaling rate to enable multi-Gb/s signaling over large gaps and long transmission lines.

Multi-bit fractional equalization has the potential to drastically increase the maximum signaling speed of inductive coupling, especially when used in conjunction with a transmission line. An optimally equalized input signal is created by preserving the rising and falling edges of the NRZ data. The larger and sharper the edge input to a transformer, the greater the amplitude of the coupled pulse. The tail of the pulse can then by removed by de-emphasizing the DC component of the NRZ input. Too little de-emphasis fails to adequately remove the tail, while too much reduces the swing of the input signal, thereby coupling less signal. By dividing each input bit into fractions based on a clock, more precise equalization can be achieved. This concept is illustrated in FIG. 30.

FIG. 30 is a graph illustrating an example multi-bit fractional EQ profile according to an embodiment of the subject matter described herein. In order to equalize out longer tails and enhance the effects of equalization, multiple bits after a transition bit may have to equalized, and each bit may be further subdivided in to portions, or fractional bits. In FIG. 30, for example, the first two bits of the waveform are shown (as “Bit 1” and “Bit 2”.) Each bit is further subdivided into four parts, labeled “A”, “B”, “C, and “D”. As can be seen in FIG. 30, each part of each bit can be individually equalized, e.g., by adjusting the output voltage—represented graphically as the height of the line—produced by the driver circuit at that particular time.

In one embodiment, a simple FIR filter composed of multiple flip-flops enables the detection of transition bits and the bits immediately following a transition, while phases of a clock can be used to create different amplitude levels within a single bit and over multiple bits.

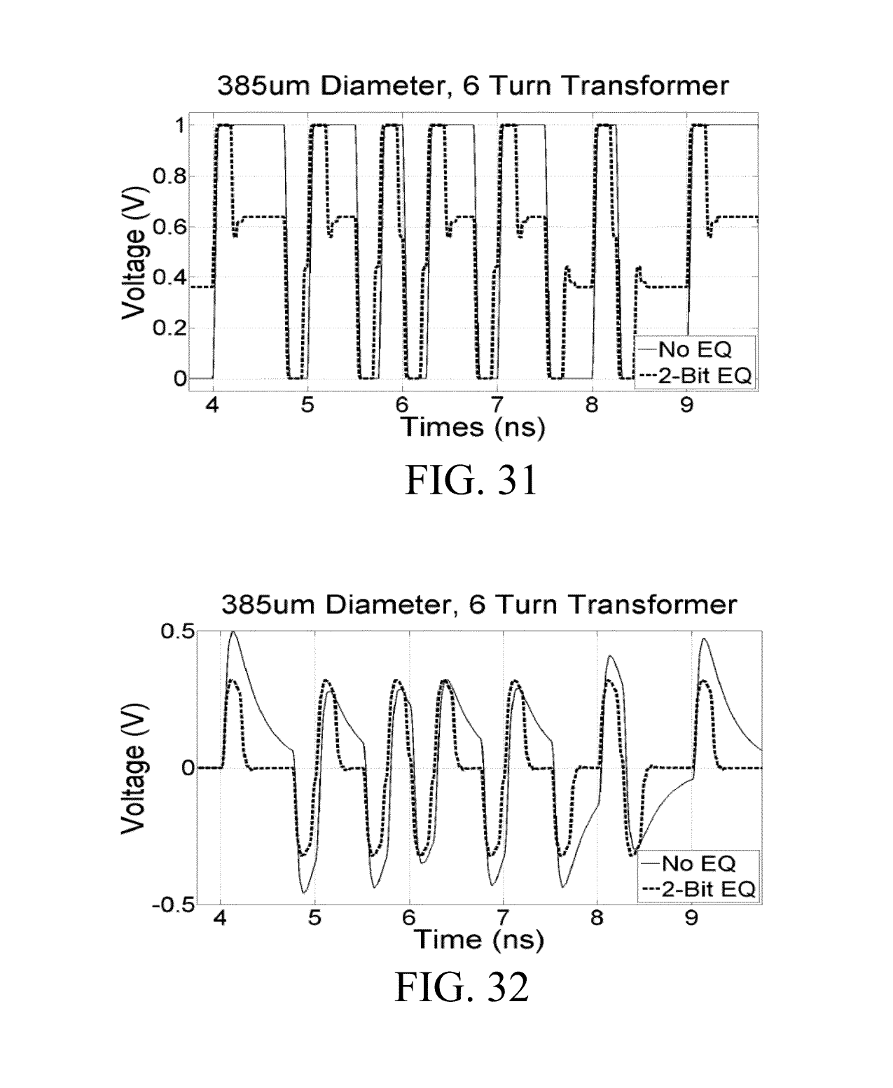

FIGS. 31 and 32 illustrate a multi-bit fractionally equalized input stream and its corresponding output stream, respectively, according to an embodiment of the subject matter described herein. FIG. 31 illustrates a multi-bit fractionally equalized input bit stream for a 385 μm (6 turns, 15 μm width & spacing) transformer. The non-equalized NRZ signal is also shown for comparison. The corresponding output signals, shown in FIG. 32, illustrate the reduction in the tail ISI achieved through equalization. The non-equalized output is also shown for comparison.

A simple pulse receiver, without the need for complex logic or clocking circuitry, can then be used to recover the full-swing NRZ data. A secondary benefit of multi-bit fractional equalization can also be observed during long sequences of ‘1’s or ‘0’s, during which the amplitude of the equalized input signal can be drastically reduced. Depending on the channel, the optimally equalized driver output is closer to true pulse-signaling than NRZ signaling. A significant amount of driver-side power can potentially be saved, while still allowing for the use of a simple low power pulse receiver.

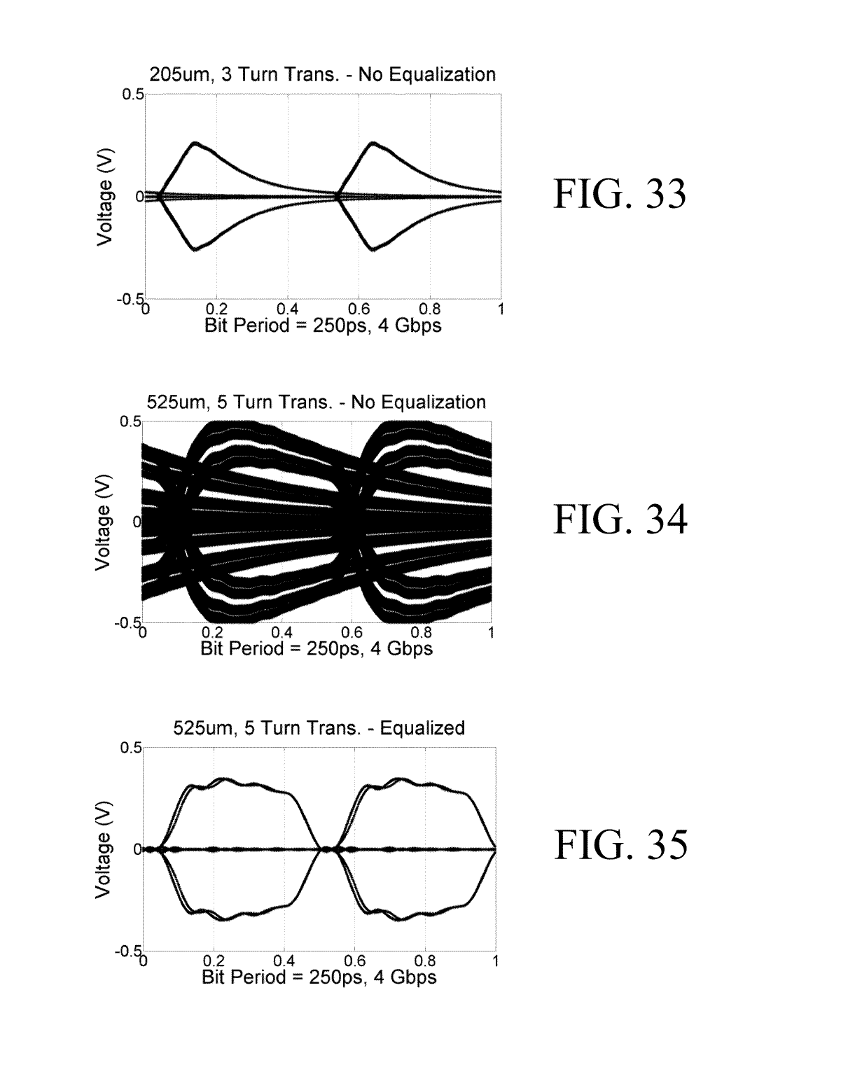

FIGS. 33 through 35 illustrate the point that using equalization, it is possible to decouple the physical parameters of a transformer from the rate at which data can be transmitted across it.

FIG. 33 is a waveform showing the natural decay time for a 205 μm diameter, 15 μm width and spacing, 3 turn transformer. A transformer having these characteristics is ideally suited to signal at 4 Gbps or less. If a larger amplitude signal is required at the receiver for error-free operation, a larger transformer, such as a 525 μm diameter, 25 μm width & spacing, 5 turn transformer can be used.

FIG. 34 is a waveform showing the eye diagram of data being transmitted at 4 Gbps using the larger transformer described above. As can be seen in FIG. 34, the increased natural decay time of the larger transformer, creates significant ISI at 4 Gbps, which makes transmission at that bit rate impossible.

FIG. 35 is a waveform showing the eye diagram of data being transmitted using the larger transformer described above, with the added operation of performing fractional equalization of the input data using the techniques described above. It can be seen that multi-bit fractional EQ produces a signal with very low ISI. In fact, successful transmission at 10+Gbps can be achieved while providing the benefits of a larger, wider pulse inherent to larger transformers. Minimizing the pitch of transformers for a specific channel still requires a tradeoff between coupling and area, but the maximum speed at which a particular transformer can signal is no longer a limiting factor.

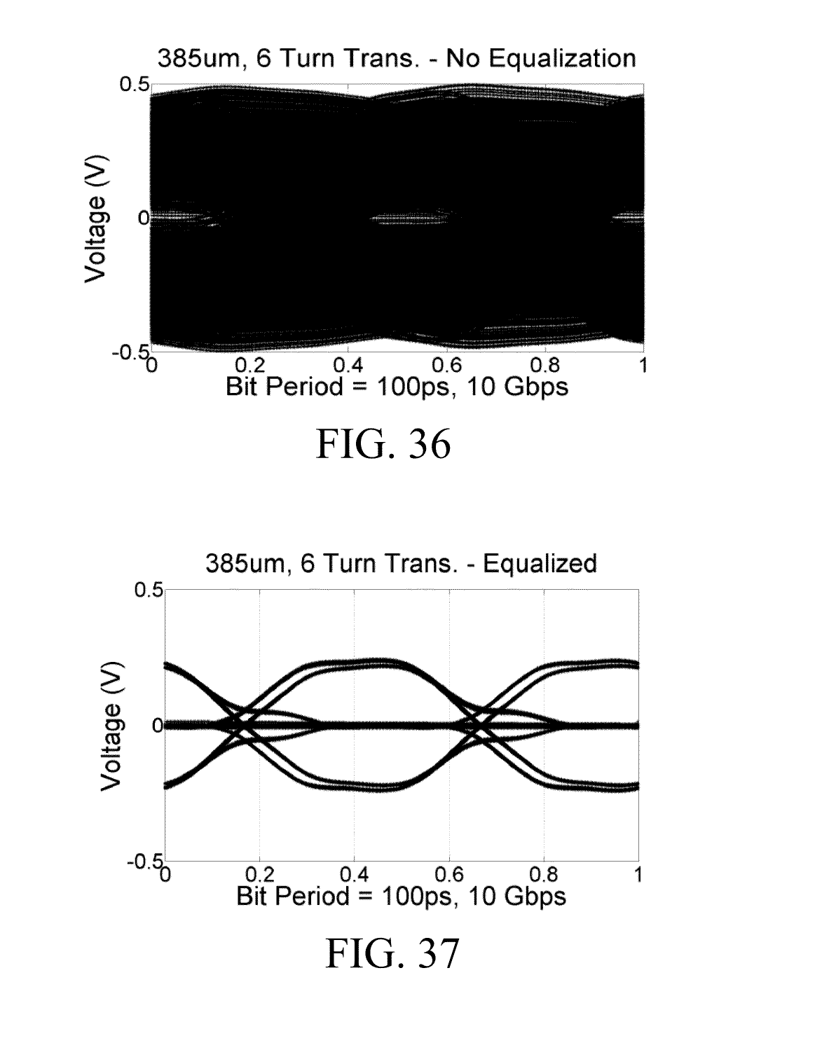

FIGS. 36 and 37 are simulated eye diagrams for signals being transmitted at 10 Gbps using the larger transformer described above, without and with equalization, respectively. These diagrams detail the improvement in eye opening for a 385 μm, 15 μm width and spacing, 6 turn transformer operating at 10 Gbps. Without equalization, shown in FIG. 36, the eye is completely closed, while driver-side equalization is able to open the eye, as shown in FIG. 37. An overview of multi-bit fractional equalization shows that for 10 different transformers, each signaling at 4 different data rates, the benefit of equalization increases as transformer size and signaling data rate increases. Transformers that were previously impossible to use for high-speed signaling can now be utilized.

By applying multi-bit fractional equalization at the driver-side, ISI in inductively coupled channels can be drastically reduced, enabling high-speed, low-power signaling, while decoupling transformer design from the desired data rate. Without equalization, the physical design of a transformer limits the maximum achievable signaling rate due to the slow decay of the pulse created when an NRZ signal is sent across a transformer. When a transformer is placed in a transmission line, the low-pass filter response of the transmission line reduces the peak amplitude of the pulse while maintaining the slow decay of the pulse's tail. In order to successfully signal across such a channel, larger transformers with better coupling may be required. As coupling increases, the maximum ISI-free signaling rate decreases, limiting high-speed operation. A large range of transformer sizes can be used for a variety of signaling rates by equalizing at the driver-side, while providing low-power signaling with minimal ISI.

The subject matter described herein includes, but is not limited to, the following embodiments:

1. An electrical connector part that includes a first mating connector face having disposed thereon a first set of inductors, and a mechanical interface that is configured to maintain the first mating connector face in closely spaced apart relation to a second mating conductor face having disposed thereon a second set of inductors to prevent DC coupling and to provide inductive AC coupling between at least one pair of inductors comprising one inductor from the first set of inductors and one inductor from the second set of inductors, where the first set of inductors includes a power inductor of a first size for transferring power and a data inductor of a second size different from the first size for transferring data.

2. The electrical connector part of embodiment 1 where the mechanical interface includes an electrically insulating layer between the first set of inductors and the second mating connector face.

3. The electrical connector part of embodiment 2 where the electrically insulating layer includes an electrically insulating material and/or mechanical structures to ensure that the first and second pluralities of inductors are separated by a gap sufficient to prevent physical contact between any of the first set of inductors and any of the second set of inductors.

4. The electrical connector part of embodiment 1 where the power inductor is larger than the data inductor.

5. The electrical connector part of embodiment 4 where the size of the power inductor is selected for efficient power transfer at a first frequency and where the size of the data inductor is selected for transfer of data at second frequency that is higher than the first frequency.

6. The electrical connector part of embodiment 1 where the power inductor includes at least one conducting loop.

7. The electrical connector part of embodiment 6 where the data inductor is located within the conducting loop of the power inductor.

8. The electrical connector part of embodiment 6 where the data inductor is located outside of the conducting loop of the power inductor.

9. The electrical connector part of embodiment 1 where the first mating connector face includes a magnetic region for coupling the first mating connector face to the second mating connector face using magnetic attraction.

10. The electrical connector part of embodiment 9 where the magnetic region provides an electrically conductive path between the first and second mating connector faces.

11. The electrical connector part of embodiment 1 where the first mating connector face includes a physical structure for securing the first mating connector face to the second mating connector face.

12. The electrical connector part of embodiment 1 where the first mating connector face includes an orientation indicator for determining the orientation of the mating connector face relative to the second mating connector face.

13. The electrical connector part of embodiment 12 where the orientation indicator includes a structure for providing an inductive connection to a corresponding structure on the second mating conductor face, a capacitive connection to a corresponding structure on the second mating conductor face, and/or a conductive connection to a corresponding structure on the second mating conductor face.

14. The electrical connector part of embodiment 1 where the first set of inductors includes a set of data inductors.

15. The electrical connector part of embodiment 14 where one of the set of data inductors has an induction characteristic that is different from another of the set of data inductors.

16. The electrical connector part of embodiment 15 where the one of the set of data inductors has a phase that is different from the phase of the other of the set of data inductors.

17. An electrical connector part that includes a first mating connector face having disposed thereon a first power inductor for transferring power and a first optical device for transmitting or receiving data, and a mechanical interface that is configured to maintain the first mating connector face in closely spaced apart relation to a second mating conductor face having disposed thereon a second power inductor for transferring power and a second optical device for transmitting or receiving data, where the mechanical interface is configured to prevent DC coupling, to provide inductive AC coupling between the first and second power inductors, and to provide optical communication between the first and second optical devices.

18. The electrical connector part of embodiment 17 where the mechanical interface includes an electrically insulating layer between the first and second power inductors.

19. The electrical connector of part 18 where the electrically insulating layer includes an electrically insulating material and/or mechanical structures to ensure that the first and second power inductors are separated by an air gap sufficient to prevent physical contact between the first and second power inductors.

20. The electrical connector part of embodiment 17 where the first power inductor includes at least one conducting loop.

21. The electrical connector part of embodiment 20 where the first optical device is located within the conducting loop of the power inductor.

22. The electrical connector part of embodiment 20 where the first optical device is located outside of the conducting loop of the power inductor.

23. The electrical connector part of embodiment 17 where the first mating connector face includes a magnetic region for coupling the first mating connector face to the second mating connector face using magnetic attraction.

24. The electrical connector part of embodiment 23 where the magnetic region provides an electrically conductive path between the first and second mating connector faces.

25. The electrical connector part of embodiment 17 where the first mating connector face includes a physical structure for securing the first mating connector face to the second mating connector face.

26. The electrical connector part of embodiment 17 where the first mating connector face includes an orientation indicator for determining the orientation of the mating connector face relative to the second mating connector face.

27. The electrical connector part of embodiment 26 where the orientation indicator includes a structure for providing an inductive connection to a corresponding structure on the second mating conductor face, a capacitive connection to a corresponding structure on the second mating conductor face, and/or a conductive connection to a corresponding structure on the second mating conductor face.

28. An electrical connector part that includes a first mating connector face having disposed thereon a first set of inductors that includes a power inductor for transferring power and a data inductor for transferring data, a mechanical interface that is configured to maintain the first mating connector face in closely spaced apart relation to a second mating conductor face having disposed thereon a second set of inductors to prevent DC coupling and provide inductive AC coupling between at least one pair of data inductors comprising one data inductor from the first set of inductors and one data inductor from the second set of inductors, and an equalization (EQ) circuit for performing multi-bit fractional equalization of the data being transmitted from the first mating connector face to the second mating connector face.

29. The electrical connector part of embodiment 28 where the mechanical interface includes an electrically insulating layer between the first set of inductors and the second mating connector face.

30. The electrical connector of part 29 where the electrically insulating layer includes an electrically insulating material, and/or mechanical structures to ensure that the first and second pluralities of inductors are separated by an air gap sufficient to prevent physical contact between any of the first set of inductors and any of the second set of inductors.

31. The electrical connector part of embodiment 28 where the power inductor is larger than the data inductor.

32. The electrical connector part of embodiment 31 where size of the power inductor is selected for efficient power transfer at a first frequency and where the size of the data inductor is selected for transfer of data at second frequency that is higher than the first frequency.

33. The electrical connector part of embodiment 28 where the power inductor includes at least one conducting loop.

34. The electrical connector part of embodiment 33 where the data inductor is located within the conducting loop of the power inductor.

35. The electrical connector part of embodiment 33 where the data inductor is located outside of the conducting loop of the power inductor.

36. The electrical connector part of embodiment 28 where the first mating connector face includes a magnetic region for coupling the first mating connector face to the second mating connector face using magnetic attraction.

37. The electrical connector part of embodiment 36 where the magnetic region provides an electrically conductive path between the first and second mating connector faces.

38. The electrical connector part of embodiment 28 where the first mating connector face includes a physical structure for securing the first mating connector face to the second mating connector face.

39. The electrical connector part of embodiment 28 where the first mating connector face includes an orientation indicator for determining the orientation of the mating connector face relative to the second mating connector face.

40. The electrical connector part of embodiment 39 where the orientation indicator includes a structure for providing an inductive connection to a corresponding structure on the second mating conductor face, a capacitive connection to a corresponding structure on the second mating conductor face, and/or a conductive connection to a corresponding structure on the second mating conductor face.

41. The electrical connector part of embodiment 28 where the first set of inductors includes a set of data inductors.

42. The electrical connector part of embodiment 41 where one of the set of data inductors has an induction characteristic that is different from another of the set of data inductors.

43. The electrical connector part of embodiment 42 where the one of the set of data inductors has a phase that is different from the phase of the other of the set of data inductors.

44. The electrical connector part of embodiment 28 where the EQ circuit performs multi-bit fractional equalization on non-return-to-zero (NRZ) data by preserving the rising and falling edges of the data but deemphasizing the direct current (DC) component of the data.

45. The electrical connector part of embodiment of embodiment 44 where the EQ circuit includes a variable gain output driver that receives as input the non-equalized NRZ data and that produces as output the equalized NRZ data.

46. The electrical connector part of embodiment 45 where the EQ circuit deemphasizes the DC component of the data by reducing the gain of the output driver during that portion of the NRZ data relative to the gain of the output driver during the rising and falling edges of the data.

47. An electrical connector part that includes a first mating connector face having disposed thereon a first set of inductors, and a mechanical interface that is configured to maintain the first mating connector face in closely spaced apart relation to a second mating conductor face having disposed thereon a second set of inductors to prevent DC coupling and provide inductive AC coupling between at least one pair of inductors comprising one inductor from the first set of inductors and one inductor from the second set of inductors, where each of the first and second pluralities of inductors includes a power inductor for transmitting power between the first and second mating connector faces and at least one data inductor for transmitting data between the first and second mating connector faces, and where the patterns of the first and second pluralities of inductors provide inductive AC coupling between at least one pair of inductors comprising a data inductor on the first mating connector face and a data inductor on the second mating connector face regardless of the orientation of the first and second mating connector faces relative to each other.

48. The electrical connector part of embodiment 47 where the mechanical interface includes an electrically insulating layer between the first set of inductors and the second mating connector face.

49. The electrical connector part of embodiment 47 where the electrically insulating layer includes an electrically insulating material and/or mechanical structures to ensure that the first and second pluralities of inductors are separated by an air gap sufficient to prevent physical contact between any of the first set of inductors and any of the second set of inductors.

50. The electrical connector part of embodiment 47 where the power inductor is larger than the data inductor.

51. The electrical connector part of embodiment 47 where the pattern of the first set of inductors is different from the pattern of the second set of inductors.

### REFERENCES

Each of the following references is incorporated herein by reference in its entirety:
[1] M. Mark, Y. Chen, C. Sutardja, C. Tang, S. Gowda, M. Wagner, D. Werthimer, and J. Rabaey, “A 1 mm³ 2 Mbps 330 fJ/b transponder for implanted neural sensors,” VLSI Circuits (VLSIC), 2011 Symposium on, Jun. 15-17, 2011, pp. 168-169.
[2] S. Mick, J. Wilson, and P. Franzon, “4 Gbps high-density AC coupled interconnection,” in Proc. IEEE Custom Integrated Circuits Conf., 2002, pp. 133-140.
[3] K. Kanda, D. D. Antono, K. Ishida, H. Kawaguchi, T. Kuroda, and T. Sakurai, “1.27 Gb/s/pin 3 mW/pin wireless superconnect (WSC) inter-face scheme,” in Proc. IEEE Int. Solid-State Circuits Conf. Digest Technical Papers, Feb. 9-13, 2003, pp. 1-10.
[4] J. Xu, S. Mick, J. Wilson, L. Luo, K. Chandrasekar, E. Erickson, and P. D. Franzon, “AC coupled interconnect for dense 3-D ICs,” in IEEE Nucl. Sci. Symp. Record, 2003, vol. 1, pp. 125-129.
[5] K. Chandrasekar, Z. Feng, J. Wilson, S. Mick, and P. Franzon, “Inductively Coupled Board to Board Connectors,” in Proc. Electronic Components and Tech. Conf., 2005, pp. 1109-1113.
[6] K. Kotani, A. Sasaki, and T. Ito, “High-Efficiency Differential-Drive CMOS Rectifier for UHF RFIDs,” Solid-State Circuits, IEEE Journal of, November 2009, vol. 44, no. 11, pp. 3011-3018.
[7] E. Erickson, J. Wilson, K. Chandrasekar, and P. D. Franzon, “Multi-bit fractional equalization for multi-Gb/s inductively coupled connectors,” in Proc. IEEE Conf. Elect. Perform. Electro. Packag., Portland, Oreg., Oct. 19-21 2009, pp. 121-124.
[8] J. Xu, “AC Coupled Interconnect for Inter-chip Communications,” Ph.D. dissertation, Dept. Elect. Eng., North Carolina State Univ., Raleigh, N.C. 2006.
[9] B. A. Chappell, T. I. Chappell, S. E. Schuster, H. M. Segmuller, J. W. Allan, R. L. Franch, and P. J. Restle, “Fast CMOS ECL receivers with 100-mV worst-case sensitivity,” Solid-State Circuits, IEEE Journal of, February 1988, vol. 23, no. 1, pp. 59-67.

It will be understood that various details of the subject matter described herein may be changed without departing from the scope of the subject matter described herein. Furthermore, the foregoing description is for the purpose of illustration only, and not for the purpose of limitation.

What is claimed is:

1. An electrical connector part comprising:
a first mating connector face having disposed thereon a first plurality of inductors; and
a mechanical interface that is configured to maintain the first mating connector face in closely spaced apart relation to a second mating conductor face having disposed thereon a second plurality of inductors to prevent DC coupling and to provide inductive AC coupling between at least one pair of inductors comprising one inductor from the first plurality of inductors and one inductor from the second plurality of inductors,
wherein the first plurality of inductors includes a power inductor of a first size for transferring power and a data inductor of a second size different from the first size for transferring data.

2. The electrical connector part of claim 1 wherein the mechanical interface includes an electrically insulating layer between the first plurality of inductors and the second mating connector face.

3. The electrical connector of part 2 wherein the electrically insulating layer comprises at least one of:
an electrically insulating material; and
mechanical structures to ensure that the first and second pluralities of inductors are separated by a gap sufficient to prevent physical contact between any of the first plurality of inductors and any of the second plurality of inductors.

4. The electrical connector part of claim 1 wherein the power inductor is larger than the data inductor.

5. The electrical connector part of claim 1 wherein the power inductor comprises at least one conducting loop and wherein the data inductor is located within the conducting loop of the power inductor.

6. The electrical connector part of claim 1 wherein the power inductor comprises at least one conducting loop and wherein the data inductor is located outside of the conducting loop of the power inductor.

7. The electrical connector part of claim 1 wherein the first mating connector face includes a magnetic region for coupling the first mating connector face to the second mating connector face using magnetic attraction.

8. The electrical connector part of claim 7 wherein the magnetic region provides an electrically conductive path between the first and second mating connector faces.

9. The electrical connector part of claim 1 wherein the first mating connector face includes an orientation indicator for determining the orientation of the mating connector face relative to the second mating connector face.

10. The electrical connector part of claim 9 wherein the orientation indicator comprises a structure for providing at least one of:
an inductive connection to a corresponding structure on the second mating conductor face;
a capacitive connection to a corresponding structure on the second mating conductor face; and
a conductive connection to a corresponding structure on the second mating conductor face.

11. The electrical connector part of claim 1 wherein the first plurality of inductors includes a plurality of data inductors.

12. The electrical connector part of claim 11 wherein one of the plurality of data inductors has an induction characteristic that is different from another of the plurality of data inductors.

13. The electrical connector part of claim 12 wherein the one of the plurality of data inductors has a phase that is different from the phase of the other of the plurality of data inductors.

14. An electrical connector part comprising:
a first mating connector face having disposed thereon a first plurality of inductors that includes a power inductor for transferring power and a data inductor for transferring data;
a mechanical interface that is configured to maintain the first mating connector face in closely spaced apart relation to a second mating conductor face having disposed thereon a second plurality of inductors to prevent DC coupling and provide inductive AC coupling between at least one pair of data inductors comprising one data inductor from the first plurality of inductors and one data inductor from the second plurality of inductors; and
an equalization (EQ) circuit for performing multi-bit fractional equalization of the data being transmitted from the first mating connector face to the second mating connector face.

15. The electrical connector part of claim 14 wherein the EQ circuit performs multi-bit fractional equalization on non-return-to-zero (NRZ) data by preserving the rising and falling edges of the data but deemphasizing the direct current (DC) component of the data.

16. The electrical connector part of claim 15 wherein the EQ circuit deemphasizes the DC component of the data by reducing the gain of an output driver that receives as input the non-equalized NRZ data and that produces as output the equalized NRZ data during that portion of the NRZ data relative to the gain of the output driver during the rising and falling edges of the data.

17. An electrical connector part comprising:
a first mating connector face having disposed thereon a first plurality of inductors; and
a mechanical interface that is configured to maintain the first mating connector face in closely spaced apart relation to a second mating conductor face having disposed thereon a second plurality of inductors to prevent DC coupling and provide inductive AC coupling between at least one pair of inductors comprising one inductor from the first plurality of inductors and one inductor from the second plurality of inductors,
wherein each of the first and second pluralities of inductors includes a power inductor for transmitting power between the first and second mating connector faces and at least one data inductor for transmitting data between the first and second mating connector faces, and wherein the patterns of the first and second pluralities of inductors provide inductive AC coupling between at least one pair of inductors comprising a data inductor on the first mating connector face and a data inductor on the second mating connector face regardless of the orientation of the first and second mating connector faces relative to each other.

18. The electrical connector part of claim 17 wherein the mechanical interface includes an electrically insulating layer between the first plurality of inductors and the second mating connector face.

19. The electrical connector part of claim 17 wherein the electrically insulating layer comprises at least one of:
an electrically insulating material; and
mechanical structures to ensure that the first and second pluralities of inductors are separated by an air gap sufficient to prevent physical contact between any of the first plurality of inductors and any of the second plurality of inductors.

20. The electrical connector part of claim 17 wherein the pattern of the first plurality of inductors is different from the pattern of the second plurality of inductors.
